(19) United States
(12) Patent Application Publication
(10) Pub. No.: US 2001/0012141 A1
(43) Pub. Date: Aug. 9, 2001

(54) Optical path managing device in an optical transmission network and a method thereof

(75) Inventors: Masaki Takai, Kawasaki (JP); Tohru Andoh, Kanazawa (JP)

Correspondence Address: HELFGOTT & KARAS, P.C., Empire State Building, 60th Floor, New York, NY, 10118, US

(73) Assignee: FUJITSU LIMITED

(21) Appl. No.: 09/730,939

(22) Filed: Dec. 6, 2000

(30) Foreign Application Priority Data
Feb. 1, 2000 (JP) 2000-023754

(51) Int. Cl. H04J 14/00; H04B 10/00

(52) U.S. Cl. 359/110; 359/123; 359/124; 359/135; 359/165

(57) ABSTRACT

A WDM communications line is used as a trunk to which an IP network or a SONET/SDH network is connected as a tributary. Additionally, an ID for identifying each wavelength or path, which is accommodated by a WDM communications line, is assigned to a frame of each wavelength. The ID for identifying a wavelength or a path, and the number held by a transmission device that configures the path are managed. When a fault occurs, the wavelength or the path on which the fault occurs is identified, and the identified wavelength or path is displayed on the screen of a supervisory control device that monitors the entire network. An administrator can recognize at first sight the path influenced by the fault other than the point at which the fault occurs, thereby efficiently maintaining and managing the network.

### BACKGROUND OF THE INVENTION

1. Field of the Invention

The present invention relates to an optical path managing device in an optical transmission network, and a method thereof.

2. Description of the Related Art

The speed of an optical transmission device has been improved in recent years, and products such as a DWDM (Dense Wavelength Division Multiplexing) device which multiplexes many wavelengths in a single optical fiber, high-speed SONET/SDH transmission devices and routers of 1.4, 10, 40 Gbps, and the like were announced by various makers.

In such a situation, end-to-end paths at an optical wavelength level in an optical transmission network are only managed by an administrator on a paper basis, or within one optical transmission device system. The optical wavelength path configuration of an entire network is not dynamically managed.

As described above, the path configuration at an optical wavelength level in the current state is managed by an administrator on a paper basis, or only the information of a path to an adjacent optical transmission device at each transmission device level is managed. Namely, the path configuration as an entire optical transmission network is not managed.

If a fault occurs and warning information is notified to a supervisory control device in the above described situation, a path on which a fault occurs cannot be identified in an entire optical transmission network although only a point at which a fault occurs (a path between transmission devices) can be identified.

Under the current circumstances, path information is managed by each transmission device in a network that is configured by optical transmission devices and their transmission paths, and a supervisory control device. As a means learning the entire configuration of a path, there is only a means managing a path configuration on a paper basis by a designer.

### SUMMARY OF THE INVENTION

An object of the present invention is to provide a device and a method which can identify a path on which a fault occurs when the fault arises.

The device, in a wavelength multiplexing communications network which interconnects networks having a plurality of protocols, according to the present invention comprises: a transmitting unit configuring the networks and the wavelength multiplexing communications network; an identifier assigning unit assigning an identifier to an optical signal carrying signals exchanged between the networks; and a supervisory controlling unit having a fault identifying unit which identifies a path on which a fault occurs based on the identifier when the fault arises in the wavelength multiplexing communications network.

The method for use in a wavelength multiplexing communications network configured by a plurality of WDM transmission devices interconnecting networks that are configured by a plurality of transmission devices and have a plurality of protocols, according to the present invention comprises: assigning an identifier to an optical signal carrying signals exchanged between the networks; and identifying a path on which a fault occurs when the fault arises in the wavelength multiplexing communications network, is configured by a plurality of WDM transmission devices.

According to the present invention, if networks are interconnected by a WDM network, an optical signal to which a signal input from a certain network to the WDM network is added is distinguished by its wavelength, and an identifier is assigned to the wavelength, so that the optical signal to which the identifier is assigned can be identified. Accordingly, it is possible to know on which network path the optical signal passes, whereby path management can be made. Particularly, only a faulty point is conventionally learned when a fault occurs. However, a path influenced by a fault can be determined by making paths manageable, according to the present invention. Here, an identifier assigned to each optical signal is not given according to the value of a wavelength, but given to identify the path of an optical signal input from a certain network. Accordingly, even if the value of the wavelength of an optical signal from a transmission device “A” to a transmission device “B” and that of the wavelength of an optical signal from the transmission device “B” to a transmission device “C” are the same, different identifiers are assigned when the paths are different.

As described above, paths are made manageable with ease, whereby a network administrator can efficiently manage a network by using a supervisory control device.

### BRIEF DESCRIPTION OF THE DRAWINGS

FIG. 1 is a schematic exemplifying the configuration of optical transmission networks and a supervisory control network;

FIG. 2 explains the principle of each device for implementing a preferred embodiment according to the present invention (No. 1);

FIG. 3 explains the principle of each device for implementing the preferred embodiment according to the present invention (No. 2);

FIG. 4 explains the principle of each device for implementing the preferred embodiment according to the present invention (No. 3);

FIG. 5 explains the principle of each device for implementing the preferred embodiment according to the present invention (No. 4);

FIG. 6 explains the control performed between an optical transmission device and a supervisory control device;

FIGS. 7A through 7C show the information tables for managing wavelength IDs in each optical transmission device and a supervisory control device;

FIGS. 8A and 8B exemplify an inter-device sequence between a wavelength transmission device and a supervisory control device, and an ID management screen display of the supervisory control device;

FIGS. 9A and 9B exemplify a process sequence between devices when a wavelength ID is automatically assigned, and an ID management screen of a supervisory control device;

FIG. 10 is a flowchart showing the process performed by the supervisory control device in the preferred embodiment shown in FIG. 9;

FIGS. 11A and 11B explain a preferred embodiment of a method assigning a wavelength ID to an optical transmission signal (No. 1);

FIGS. 12A through 12D explain the preferred embodiment of the method assigning a wavelength ID to an optical transmission signal (No. 2);

FIGS. 13(a) and 13(b) explain the preferred embodiment of the method assigning a wavelength ID to an optical transmission signal (No. 3);

FIGS. 14A and 14B explain the method transmitting an optical transmission signal by adding an information byte to a frame while being transmitted, and by burying a wavelength ID, which is assigned to each optical transmission device and managed, in the information byte (NO. 1);

FIG. 15 explains the method transmitting an optical transmission signal by adding an information byte to a frame while being transmitted, and by burying a wavelength ID, which is assigned to each optical transmission device and managed, in the information byte (NO. 2);

FIG. 16 shows the flows of signals when a wavelength ID is transferred in each optical transmission network (No. 1);

FIG. 17 shows the signal flows when a wavelength ID is transferred in each optical transmission network (No. 2);

FIG. 18 exemplifies the reception of a wavelength ID, the procedure for managing a wavelength ID, and a management screen in a supervisory control device (No. 1);

FIG. 19 exemplifies the reception of a wavelength ID, the procedure for managing a wavelength ID, and a management screen in the supervisory control device (No. 2);

FIG. 20 exemplifies the reception of a wavelength ID, the procedure for managing a wavelength ID, and a management screen in the supervisory control device (No. 3);

FIGS. 21A through 21C explain the procedure identifying a point at which a fault occurs according to warning information notified from each optical transmission device at the time of a fault, and the process identifying the path on which the fault occurs (No. 1);

FIG. 22 explains the procedure identifying a point at which a fault occurs according to warning information notified from each optical transmission device at the time of a fault, and the process identifying the path on which the fault occurs (No. 2);

FIG. 23 explains the procedure identifying a point at which a fault occurs according to warning information notified from each optical transmission device at the time of a fault, and the process identifying the path on which the fault occurs (No. 3);

FIG. 24 explains the procedure identifying a point at which a fault occurs according to warning information notified from each optical transmission device at the time of a fault, and the process identifying the path on which the fault occurs (No. 4);

FIGS. 25A through 25C explain a specific example of a process assigning a wavelength ID (No. 1);

FIG. 26 explains a specific example of the process assigning a wavelength ID (No. 2);

FIG. 27A through 27C explain a specific example of a process automatically assigning a wavelength ID (No. 1);

FIG. 28 explains a specific example of the process automatically assigning a wavelength ID (No. 2);

FIG. 29 explains a specific example of a process assigning a wavelength ID in an optical transmission device network;

FIG. 30 explains another specific example of the process assigning a wavelength ID in an optical transmission device network;

FIG. 31 shows a specific example explaining a process transferring a wavelength ID in an optical transmission device network (No. 1);

FIG. 32 shows a specific example explaining the process transferring a wavelength ID in the optical transmission device network (No. 2);

FIG. 33 shows a specific example explaining the procedure for managing a communications path in a central control center (No. 1);

FIG. 34 shows a specific example explaining the procedure managing a communications path in the central conrtrol center (No. 2);

FIG. 35 explains a specific example of a fault managing unit in the central control center (No. 1);

FIG. 36 explains a specific example of the fault managing unit in the central control center (No. 2);

FIG. 37 explains a specific example of the fault managing unit in the central control center (No. 3);

FIG. 38 explains one example of a display on the screen of a supervisory control device when a plurality of faults occur at one time (No. 1);

FIG. 39 explains one example of a display on the screen of the supervisory control device when a plurality of faults occur at one time (No. 2);

FIG. 40 explains one example of a display on the screen of the supervisory control device when a plurality of faults occur at one time (No. 3);

FIG. 41 explains one example of a display on the screen of the supervisory control device when a plurality of faults occur at one time (No. 4);

FIG. 42 shows another example of a display on the screen of the supervisory control device when a plurality of faults occur (No. 1);

FIG. 43 shows another example of the display on the screen of the supervisory control device when a plurality of faults occur (No. 2);

FIG. 44 shows another example of a display on the screen of the supervisory control device when a plurality of faults occur (No. 3); and

FIG. 45 shows another example of a display on the screen of the supervisory control device when a plurality of faults occur (No. 4).

### DESCRIPTION OF THE PREFERRED EMBODIMENTS

The present invention is intended to manage the configuration of optical wavelength paths in an entire optical transmission network, and to provide a means for a supervisory control at an optical wavelength level in an optical transmission network configured by DWDM devices and optical transmission devices such as a SONET/SDH transmission device, a high-speed router, etc.

According to the present invention, a wavelength ID is assigned to each wavelength, and a wavelength ID, which is processed by each transmission device, is notified to a supervisory control device, so that the connection form or the path configuration of each optical transmission device is recognized on the supervisory control device side. As a result, on which path and on which wavelength a fault occurs can be identified according to warning information notified from an optical transmission device based on path information when the fault arises.

By executing an optical path management method according to the present invention between different devices configuring a transmission line, it becomes possible to efficiently manage end-to-end paths in all transmission lines by a single supervisory control device, and to identify a faulty path and point when a fault occurs.

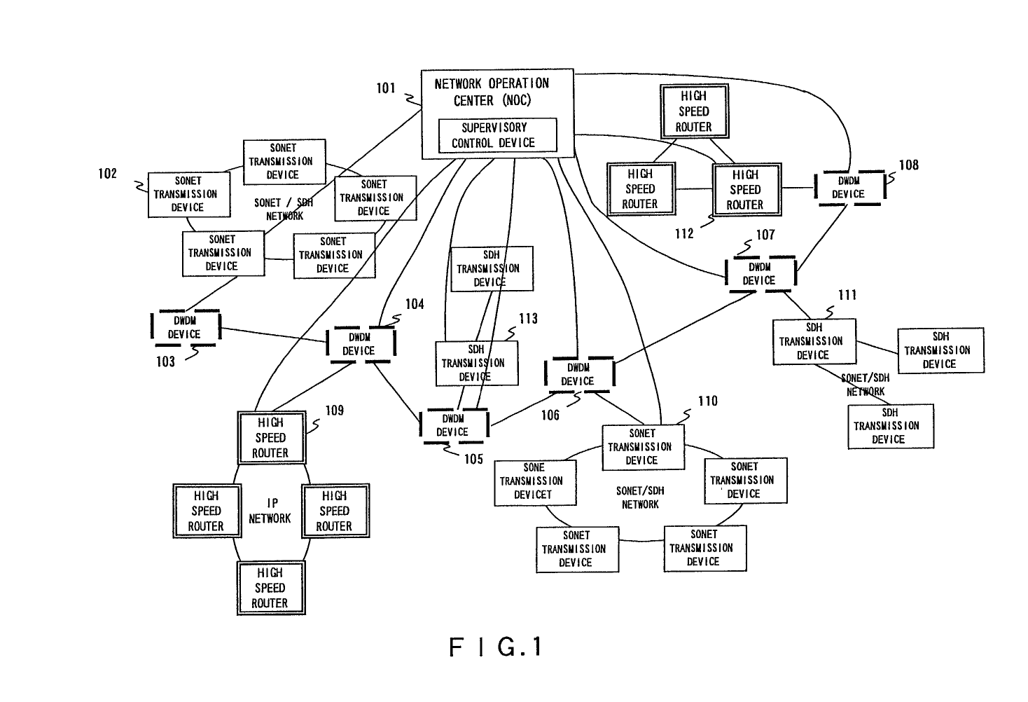

FIG. 1 exemplifies the configuration of optical transmission networks and a supervisory control network.

This figure depicts the configuration of each optical transmission network (a SONET/SDH network and an IP network), and a supervisory control network between optical transmission devices being the points connecting with higher-level networks, DWDM devices 103 through 108, and a supervisory control device 101. Lines connecting the DWDM devices 103 through 108 are WDM lines transmitting wavelength-multiplexed signals, and configure the trunk paths of the network shown in FIG. 1. The SONET/SDH networks and the IP networks, which are tributaries, are connected to the DWDM devices 103 through 108. The SONET/SDH networks and the IP networks are connected to the DWDM devices 103 through 108 via SONET transmission devices 102 and 110, SDH transmission devices 111 and 113, and high-speed routers 109 and 112. These networks transmit/receive signals to/from trunks. In the SONET/SDH networks or in the IP networks, fault information within a network itself is managed in compliance with their respective standards, and each node is configured to be able to receive fault information. Accordingly, a supervisory control device at a network operation center (NOC or a central control center) 101 is configured to monitor a single transmission device 102, 109, 110, 112, or 113 in each of the tributary networks, and the DWDM devices 103 through 108 in the trunks. The network operation center 101 is connected to the above described transmission devices 102 and 109 through 113, and the DWDM devices 103 through 108 by dedicated networks using IP protocols, such as a CAP net, etc., and is configured to obtain fault information from the transmission devices or the DWDM devices.

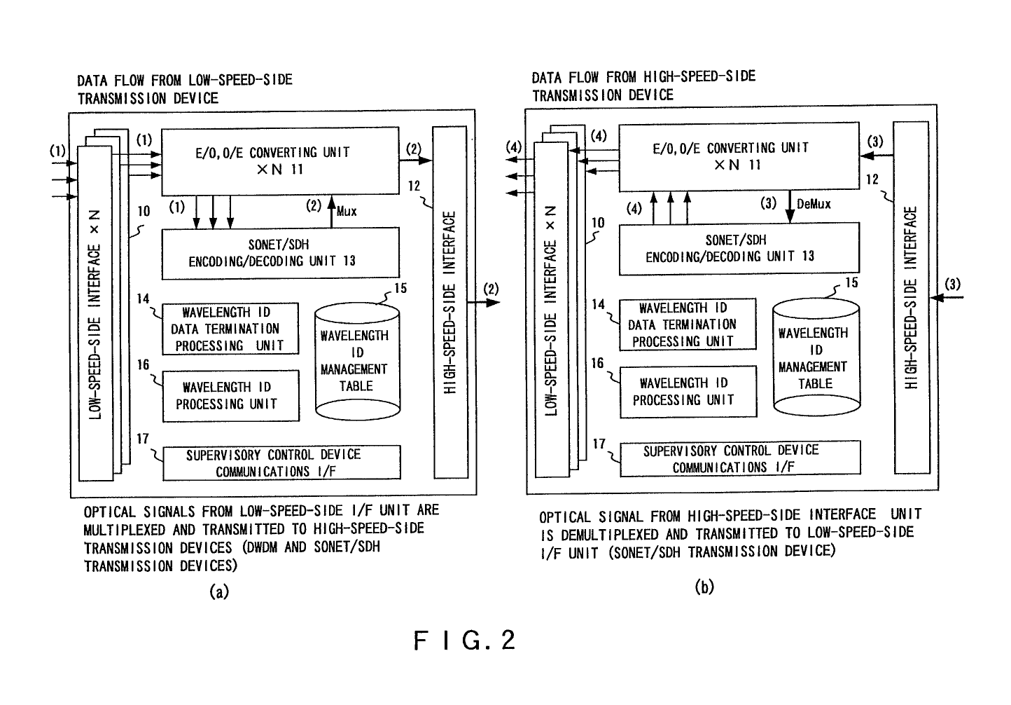

FIGS. 2 through 5 explain the principle of each of the devices for implementing a preferred embodiment according to the present invention.

FIG. 2 shows the principle of the configuration of a SONET/SDH transmission device.

The SONET/SDH transmission device is a device which transmits a high-speed optical signal (2) to which low-speed optical signals of 50 Mbps, etc. (1) are multiplexed, or a device which demultiplexes a multiplexed optical signal (3) into low-speed optical signals (4), and transmits the demultiplexed signals.

As shown in FIG. 2(a), low-speed-side interface units 10 accommodate optical signals (1) of a plurality of low-speed-side transmission devices. The optical signals accommodated by the low-speed-side interface units 10 are converted into electric signals by E/O, O/E converting units 11. Their SOHs (Section OverHeads) are checked by a SONET/SDH encoding/decoding unit 13. Then, a fault occurrence is monitored based on the information stored in an SOH, and the plurality of low-speed signals are multiplexed to one optical signal (2). The multiplexed signal is then encoded, again converted into an optical signal by the E/O, O/E converting units 11, and transmitted to an adjacent optical transmission device via a high-speed-side interface unit 12.

Inversely, as shown in FIG. 2(b), an optical signal (3) accommodated by the high-speed-side interface 12 is converted into an electric signal by the E/O, O/E converting units 11. Its SOH is checked and a fault occurrence is monitored by the SONET/SDH encoding/decoding unit 13. The electric signal is again input to the E/O, O/E converting units 11, converted into optical signals, and transmitted to an adjacent optical transmission device via the low-speed-side interface units 10.

The SONET/SDH transmission device further comprises a supervisory control device communication I/F 17 for communicating with a supervisory control device.

In this preferred embodiment, a wavelength ID data termination processing unit 14 for terminating a wavelength ID assigned to an optical signal, a wavelength ID processing unit 16 for processing a terminated wavelength ID and for managing and controlling a wavelength ID at the time of an initial setting, and a wavelength ID management table 15 storing a wavelength ID are further added.

The wavelength ID data termination processing unit 14, the wavelength ID management table 15, the wavelength ID processing unit 16, and the supervisory control device communication I/F 17 will be described in detail later.

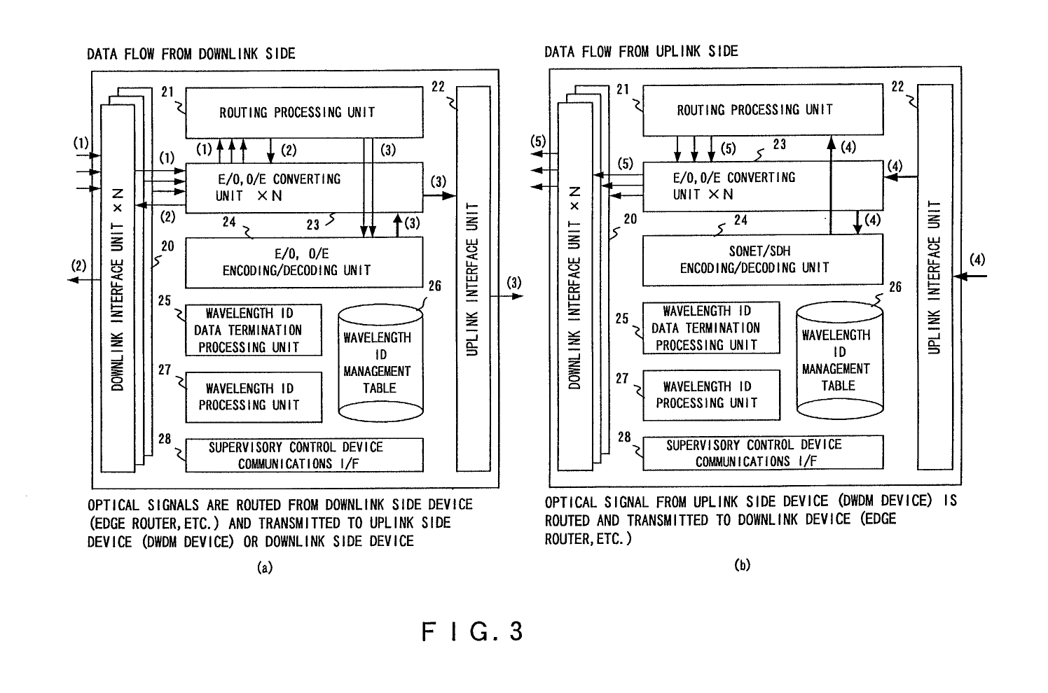

FIG. 3 shows the principle of the configuration of a high-speed router.

The high-speed router is a device routing data (1) from a downlink to an uplink, or data (4) from an uplink to a downlink.

As shown in FIG. 3(a), downlink interface units 20 accommodate data (1) from an edge router (a router which directly interfaces with a lower-level network), and the like. The accommodated data are converted into electric signals by E/O, O/E converting units 23, and divided into routing data (3) for the uplink side and routing data (2) for the downlink side by a routing processing unit 21.

The data (3) for the uplink side is encoded by a SONET/SDH encoding/decoding unit 24, again converted into an optical signal by the E/O, O/E converting units 23, and transmitted to an adjacent optical transmission device via an uplink interface unit 22.

The data (2) for the downlink side is converted into an optical signal by the E/O, O/E converting units 23, and transmitted to an adjacent optical transmission device via the downlink interface units 20.

Inversely, as shown in FIG. 3(b), an optical signal (4) accommodated by the uplink interface unit 22 is converted into an electric signal by the E/O, O/E converting units 23. Its SOH is checked and a fault occurrence is monitored by the SONET/SDH encoding/decoding unit 24. The electric signal is then demultiplexed into low-speed signals, and the routing of each of the signals to the downlink side is determined. The signals are again converted into optical signals (5) by the E/O, O/E converting units 23, and transmitted to an adjacent optical transmission device via the respective downlink interface units 20.

The high-speed router further comprises a supervisory control device communication I/F 28 for communicating with a supervisory control device. In this preferred embodiment, a wavelength ID data termination processing unit 25 for terminating a wavelength ID assigned to an optical signal, a wavelength ID processing unit 27 for processing a terminated wavelength ID and for managing and controlling a wavelength ID management control table 26 at the time of an initial setting, and a wavelength ID management table storing a wavelength ID are added. The wavelength ID data termination processing unit 25, the wavelength ID management table 26, and the wavelength ID processing unit 27 will be described in detail later.

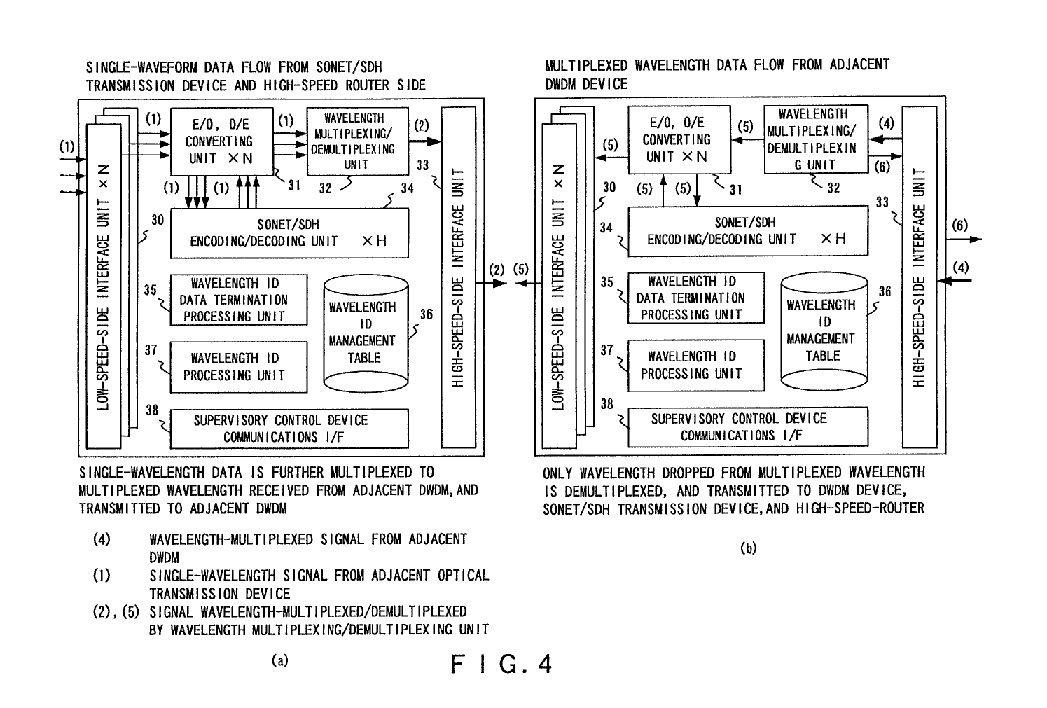

FIG. 4 shows the principle of the configuration of a DWDM device.

The DWDM device is a device which multiplexes the wavelengths of optical signals from a SONET/SDH transmission device and a high-speed router, and transmits the multiplexed signal, or a device which demultiplexes a wavelength-multiplexed optical signal from an adjacent WDM device, and transmits the demultiplexed signals by relay.

As shown in FIG. 4(a), low-speed-side interface units 30 accommodate optical signals (1) from SONET/SDH transmission devices or high-speed routers. The signal-wavelength signals (1) accommodated by the low-speed-side interface units 30 are converted into electric signals by E/O, O/E converting units 31, and their SOHs are checked and a fault occurrence is monitored by a SONET/SDH encoding/decoding unit 34. After the signals are again converted into optical signals by the E/O, O/E converting units 31, they are wavelength-multiplexed (2) by a wavelength multiplexing/demultiplexing unit 32, and transmitted via a high-speed-side interface unit 33.

Inversely, as shown in FIG. 4(b), a wavelength-multiplexed signal (4) from an adjacent DWDM device is accommodated by the high-speed-side interface unit 33. The accommodated wavelength-multiplexed signal (4) is input to the wavelength multiplexing/demultiplexing unit 32. Optical signals to be transmitted by relay are returned to the high-speed-side interface unit 33 unchanged, and transmitted from the high-speed-side interface unit 33 to the adjacent DWDM device. In the meantime, the optical signals (5) demultiplexed into respective wavelengths by the wavelength multiplexing/demultiplexing unit 32 are converted into electric signals by the E/O, O/E converting units 31. Their SOHs are checked and a fault occurrence is monitored by the SONET/SDH encoding/decoding unit 34. The signals are then encoded, again converted into optical signals (5) by the E/O, O/E converting unit 31, and transmitted via the low-speed-side interface units 30.

The DWDM device further comprises a supervisory control device communication I/F 38 for communicating with a supervisory control device.

In this preferred embodiment, a wavelength ID data termination processing unit 35 for terminating a wavelength ID assigned to an optical signal, a wavelength ID processing unit 37 for processing a terminated wavelength ID and for managing and controlling a wavelength ID at the time of an initial setting, and a wavelength ID management table 36 storing wavelength IDs are added. The wavelength ID data termination processing unit 35, the wavelength ID management table 36, and the wavelength ID processing unit 37 will be described in detail later.

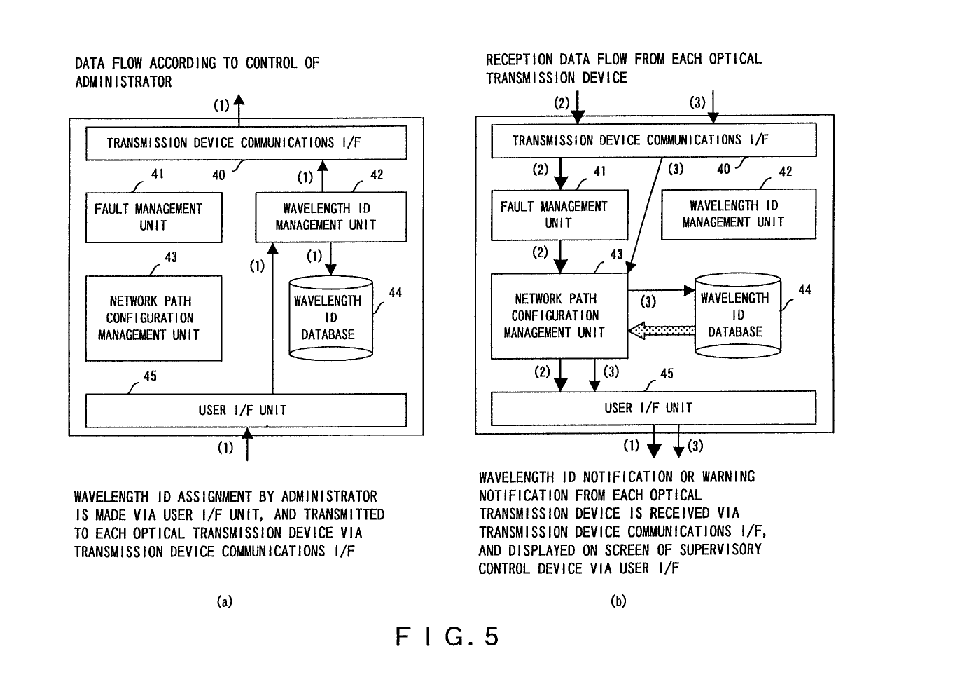

FIG. 5 shows the principle of the configuration of a supervisory control device.

The supervisory control device is a device which makes operation settings (1) and network management (3). This device comprises a user I/F unit 45 as an interface with an operator such as an administrator, etc., and communicates with a SONET/SDH transmission device, a high-speed router, and a DWDM device via a transmission device communication I/F 40. The supervisory control device is, for example, an information processing terminal such as a workstation.

As shown in FIG. 5(a), an input (1) from a user is transmitted from a user I/F unit 45 to a wavelength ID management unit 42, which assigns a wavelength ID. The assigned wavelength ID is transmitted and registered to a wavelength ID database 44, and also transmitted from a transmission device communication I/F 40 to each optical transmission device via a supervisory control network (configured by a CAP net, OSI, LAN, etc.).

Additionally, as shown in FIG. 5(b), a wavelength ID notification (3) or a warning notification (2) from each optical transmission device is received via the transmission device communication I/F 40, and displayed on the screen of the supervisory control device via the user I/F unit 45. For example, if the wavelength ID notification (3) is received by the transmission communication I/F 40, it is passed to a network path configuration management unit 43, and displayed via the user I/F unit 45 after the wavelength ID database 44 is referenced. As a result, a user can verify which wavelength ID is assigned to which optical transmission device. Additionally, after the fault notification (2) from each optical transmission device is received by the transmission device communication I/F 40, it is transmitted to a fault management unit 41. The contents of the fault are determined, and on which path the fault occurs is detected by a network path configuration management unit 43. Then, the contents of the fault and the path on which the fault occurs are displayed for the user via the user I/F unit 45.

In this preferred embodiment, a wavelength ID management unit 42 for managing wavelength IDs in order to assign a wavelength ID, a wavelength ID database 44 for managing the data of wavelength IDs, and a network path configuration management unit 43 for managing network paths in conjunction with the managed data are added. Also a capability managing an image of a fault on a GUI is added to the fault management unit 41 in conjunction with the added capabilities.

In this preferred embodiment, each wavelength transmission device (a SONET/SDH transmittion device, a high-speed router, etc.) assigns a wavelength ID to a SONET/SDH frame (SOH) or to a byte added to the SONET/SDH frame, and transmits the frame, so that the path configuration at each wavelength level is recognized and managed in a centralized manner. Consequently, a path on which a fault occurs can be identified according to a fault notification from a transmission device.

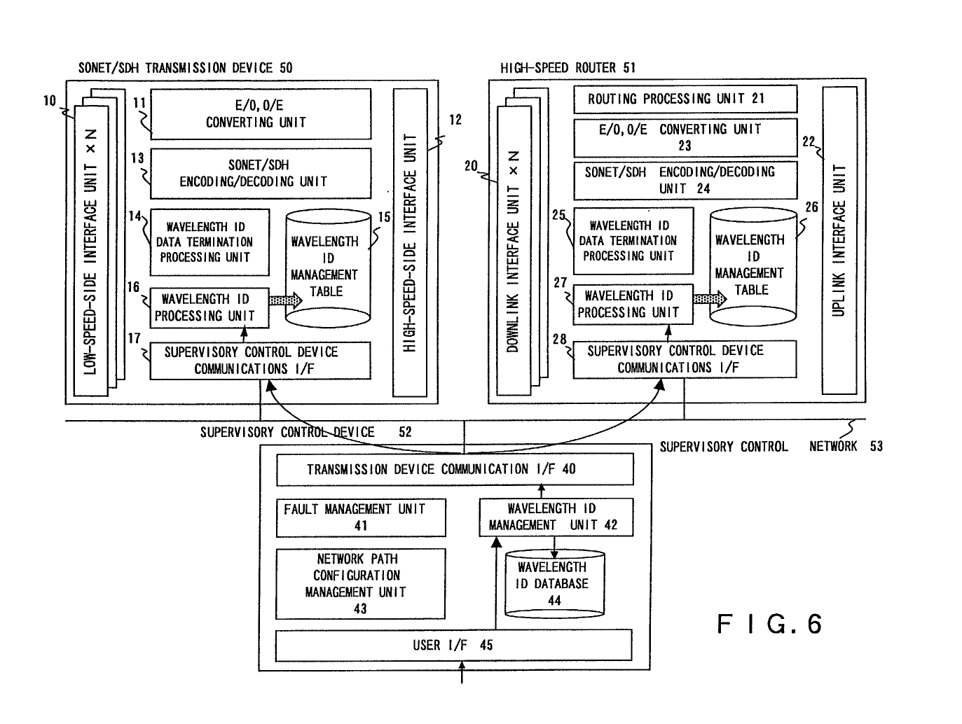

FIG. 6 explains the control performed between an optical transmission device and a supervisory control device.

In this figure, the same constituent elements as those shown in FIGS. 2 through 5 are denoted with the same reference numerals.

In a supervisory control network 53, wavelength transmission devices (a SONET/SDH transmission device 50 and a high-speed router 51 in FIG. 6) and a supervisory control device (52 in FIG. 6) are connected by supervisory control device I/Fs (17 and 28 in FIG. 6) and a transmission device communication I/F (40 in FIG. 6).

When a network is configured, an administrator assigns wavelength IDs to optical transmission devices. The optical transmission devices and the supervisory control device manage their wavelength ID information by using wavelength ID management tables (15 and 26 in FIG. 6) and a wavelength ID database (44 in FIG. 6).

When a user operates the supervisory control device 52 and inputs a wavelength ID, the input wavelength ID is passed to a wavelength ID management unit 42 within the supervisory control device 52, registered to the wavelength ID database 44, and transmitted from the transmission device communication I/F 40 to the SONET/SDH transmission device 50 and the high-speed router 51 via the supervisory control network 53. The SONET/SDH transmission device 50 receives the transmitted wavelength ID with the supervisory control device communication I/F 17, and processes its data with a wavelength ID processing unit 16, and registered to the wavelength ID management table 15. In the meantime, the high-speed router 51 receives the transmitted wavelength ID with the supervisory control device communication I/F 28, processes its data with a wavelength ID processing unit 27, and registered to the wavelength ID management table 26 in a similar manner.

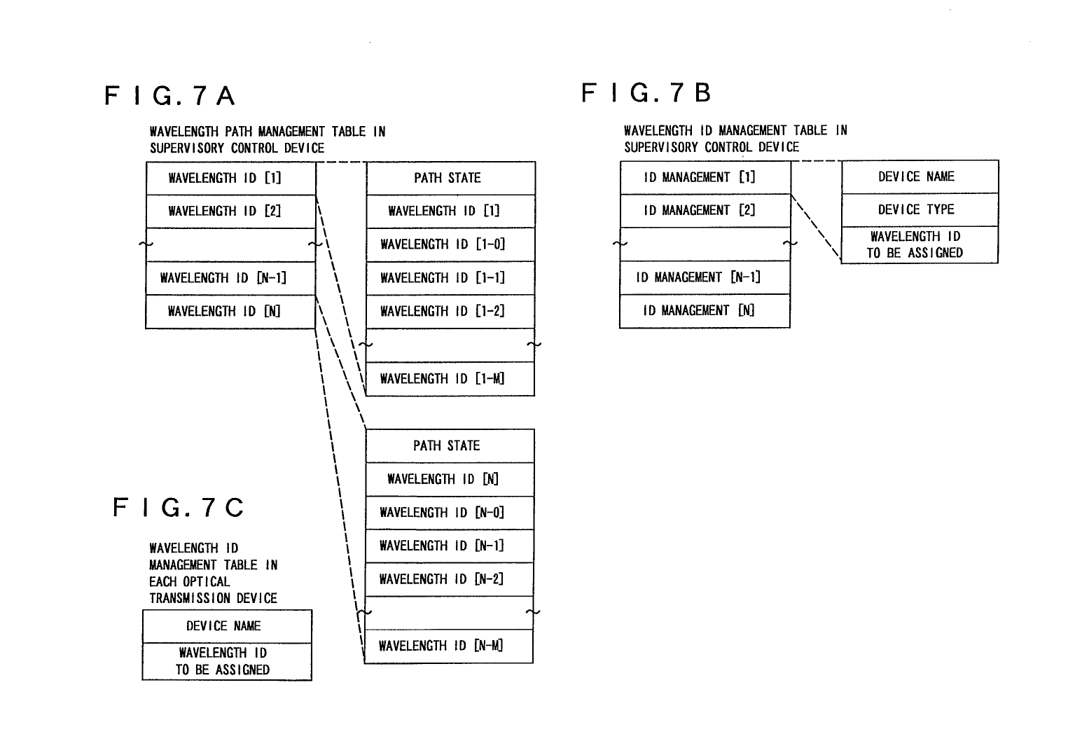

FIGS. 7A through 7C show the information tables for managing wavelength IDs in each optical transmission device and a supervisory control device.

The wavelength path management and the wavelength ID management tables, which are possessed by the supervisory control device and are shown in FIGS. 7A and 7B, are respectively a table for managing the path of each wavelength and a table for managing the information of each wavelength ID on the supervisory control device side. The wavelength ID management table, which is possessed by each optical transmission device side and is shown in FIG. 7C, is a table for managing the wavelength ID of each optical transmission device side.

The supervisory control device comprises two tables shown in FIGS. 7A and 7B. The table shown in FIG. 7A is intended to manage wavelength paths. An entry for a path state, an entry for identifying a device which is the starting point of the path assinged a wavelength ID, and a serial number assigned to each path are registered to this table for each wavelength ID, as shown in the right-hand-side of FIG. 7A. Here, the serial number assigned to each path is explained by taking the case of a wavelength ID 1 in FIG. 7A as an example. A wavelength ID[1-0] indicates a “0”th path among the paths to which the wavelength ID 1 is assigned. Similarly, a wavelength ID[1-1] is the first path among the paths to which the wavelength ID 1 is assigned. Such a serial number (tributary number) is stored in each optical transmission device, and indicates a path between optical transmission devices.

FIG. 7B exemplifies the wavelength ID management table possessed by the supervisory control device. In this table, the name of a device which is the starting point of a path, the type of the device, and an assigned wavelength ID are arranged as entries for each wavelength ID.

By using the tables shown in FIGS. 7A and 7B as described above, the supervisory control device can learn which wavelength ID is assigned to a path starting from which device, and through which transmission device(s) the path is formed.

In this preferred embodiment, an ID assigned to a path is referred to as a wavelength ID. This is because one wavelength forms one path, and this does not mean that the same ID is assigned to the wavelengths having the same value. Namely, if an optical signal having a certain wavelength is used from a transmission device “A” to a transmission device “B”, and if an optical signal having the same wavelength is used from the transmission device “B” to a transmission device “C”, different wavelength IDs are assigned between the transmission devices A and B and between B and C so as to make the paths manageable, although the optical signals have the same wavelength.

FIG. 7C exemplifies the wavelength ID management table possessed by each optical transmission device. In each optical transmission device, the name of the device itself and the wavelength ID accommodated by the device itself are registered, and the information of the path is ready to be transmitted to a supervisory control device at any time.

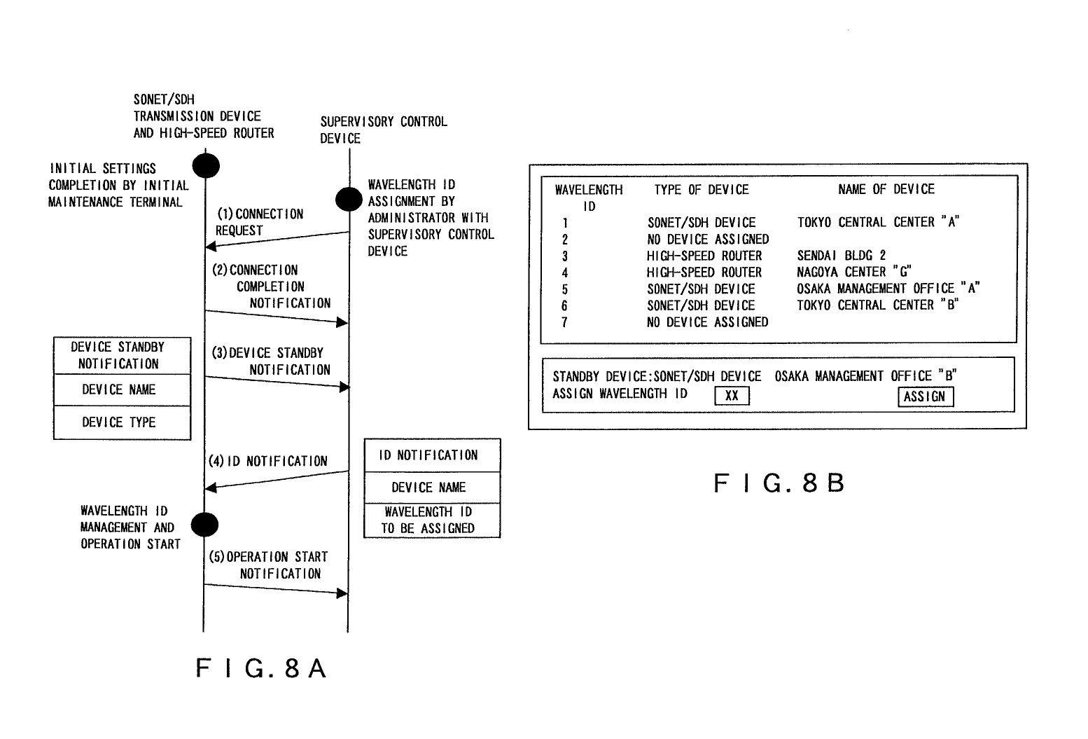

FIG. 8A shows an inter-device sequence between a wavelength transmission device and a supervisory control device, whereas FIG. 8B shows an example of a display on an ID management screen of the supervisory control device.

In this preferred embodiment, an administrator manually assigns a wavelength ID to each transmission wavelength handled by each optical transmission device (a SONET/SDH transmission device, a high-speed (IP) router, etc.) in the optical transmission network shown in FIG. 1.

As shown in the sequence of FIG. 8A, the initial settings for a device (such as a SONET/SDH transmission devices and a high-speed router), which transmits a wavelength to a DWDM device in an optical transmission device network, are made beforehand by an administrator.

Thereafter, the administrator assigns a wavelength ID to each optical transmission device by using a supervisory control device. First of all, a connection request (1) is issued from a supervisory control terminal (device) to each optical transmission device via a supervisory control network. A connection completion notification (2) is returned from the optical transmission device as a response. The connection is then established between the supervisory control terminal (device) and the optical transmission device (if the initial settings have not been completed upon receipt of the connection request from the supervisory control device, an unable-to-connect response is returned). After the connection is established, the optical transmission device transmits a device standby notification (3) to the supervisory control device, and notifies the supervisory control device of the name and the type of the device. The current wavelength ID assignment state is made visible on the screen of the supervisory control device according to the information of the wavelength ID table managed within the supervisory control device (refer to FIG. 8B). The administrator then determines an empty wavelength ID to be assigned, and notifies the optical transmission device as an ID notification (4). The optical transmission device manages the notified wavelength ID within the device itself, transmits an operation start notification (5) to the supervisory control device as a response, and starts its operation at the same time.

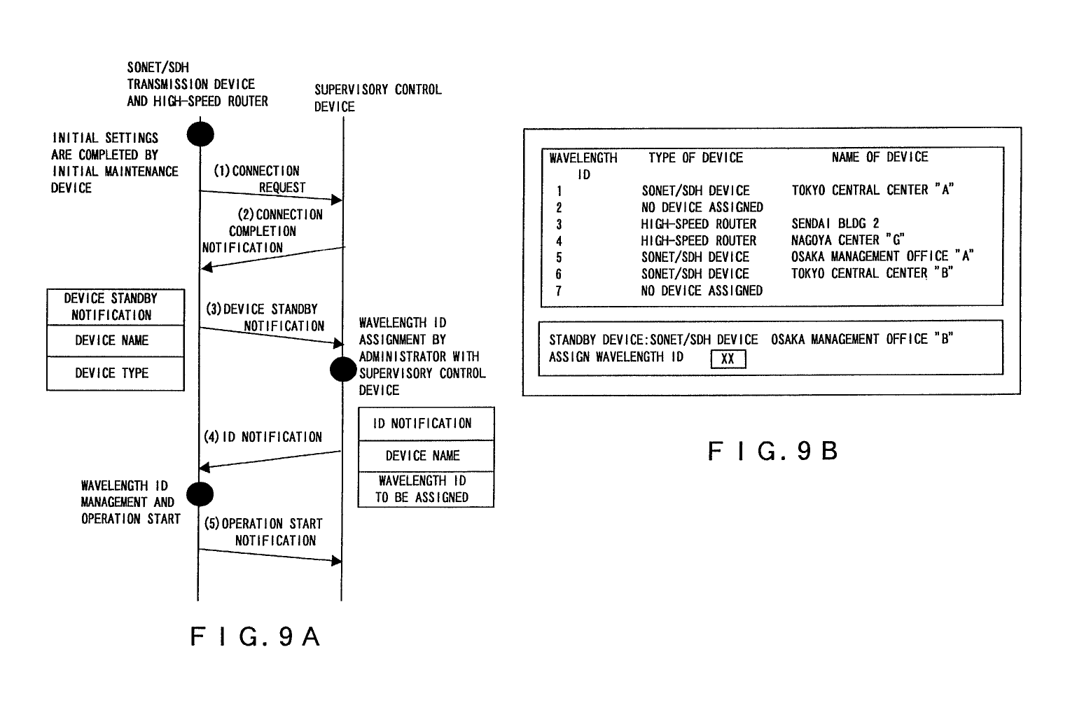

FIG. 9A shows the inter-device process sequence when a wavelength ID is automatically assigned, whereas FIG. 9B shows an example of a display on an ID management screen of a supervisory control device.

In the preferred embodiment shown in FIGS. 8A and 8B, a wavelength ID is assigned by an administrator. This preferred embodiment, however, is a method with which each wavelength transmission device (a SONET/SDH transmission device or a high-speed router) automatically assigns a wavelength ID by negotiating with a supervisory control device, and notifies respective optical transmission devices of the wavelength ID, and the wavelength ID is managed by the supervisory control device.

Note that the configuration of the supervisory control network and the data management tables are similar to those shown in FIGS. 6 and 7A through 7C.

As shown in the sequence of FIG. 9A, the initial settings for a device (a SONET/SDH transmission device or a high-speed router), which transmits a wavelength to a DWDM device in an optical transmission device network, are made beforehand by an administrator.

After the settings are completed, an optical transmission device side automatically issues a connection request (1) to a supervisory control device via a supervisory control network. The supervisory control device returns a connection completion notification (2) as a response. The connection is then established. After the connection is established, the optical transmission device transmits a device standby notification (3), and notifies the supervisory control device of the name and the type of the device.

The current wavelength ID assignment state is made visible on the screen of the supervisory control device according to the information of the wavelength ID table managed by the supervisory control device, and an empty wavelength ID is notified to the optical transmission device with an ID notification (4). The optical transmission device manages the notified wavelength ID within the device itself, and transmits an operation start notification (5) as a response. The optical transmission device starts its operation simultaneously with the transmission of the operation start notification.

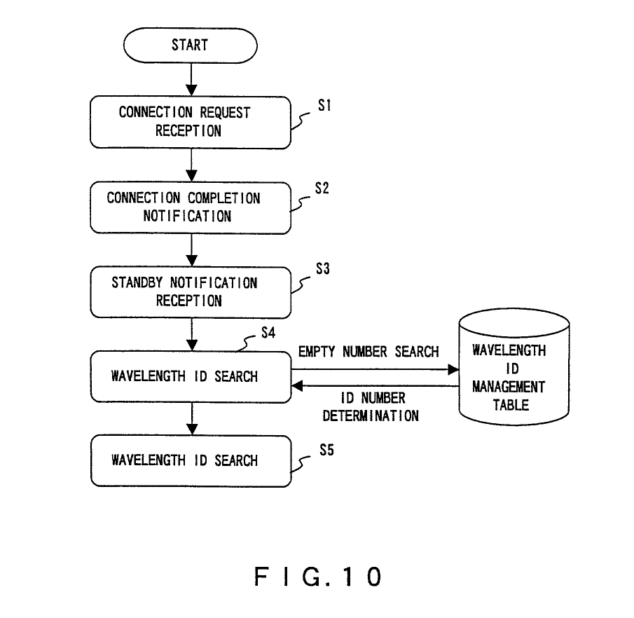

FIG. 10 is a flowchart showing the process performed by the supervisory control device in the preferred embodiment shown in FIGS. 9A and 9B.

First of all, upon completion of the settings for a SONET/SDH transmission device or a high-speed router, which are made by an unconnected terminal, the transmission device itself issues a connection request to the supervisory control device. Upon receipt of the connection request in step S1, the supervisory control device returns a connection completion notification to the transmission device as a response to the connection request in step S2, and waits for receiving a device standby notification from the transmission device side in step S3. Upon receipt of the device standby notification, the supervisory control device searches the wavelength ID management table for empty numbers in step S4. If empty numbers are found, the supervisory control device determines an adequate number as a wavelength ID to be notified among the empty numbers. Then, the supervisory control device notifies the transmission device that issued the connection request of the wavelength ID in step S5. Here, various existing methods are available as a method determining a wavelength ID among empty numbers.

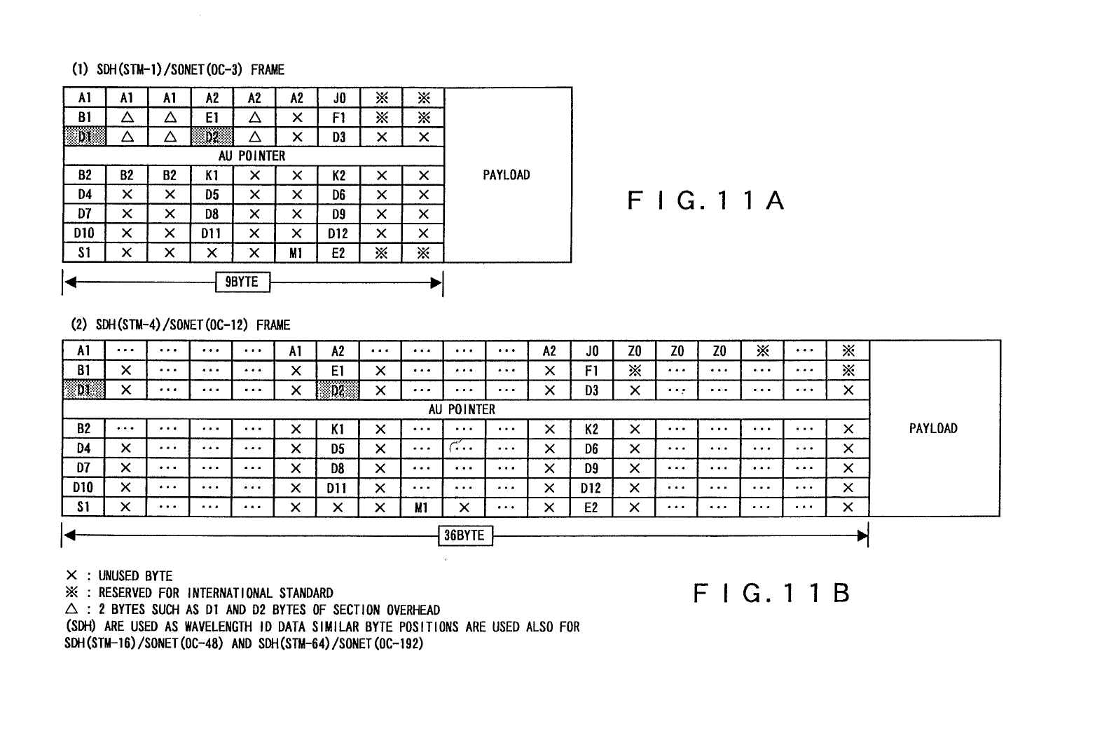

Figs. 11A through 13 explain one preferred embodiment of a method assigning a wavelength ID to an optical transmission signal.

This preferred embodiment is a method burying the wavelength ID, which is assigned to and managed by each optical transmission device in the above described preferred embodiments, in a particular byte of a section overhead (SOH) of a frame while being transmitted, and transmitting the frame.

FIGS. 11A and 11B exemplify the frame structure for assigning a wavelength ID to a section overhead (SOH) of a SONET/SDH frame, and for transmitting the frame, and the frame structure where D1 and D2 bytes are used to assign a wavelength ID. FIG. 11A shows an SDH STM-1 frame or a SONET OC-3 frame, whereas FIG. 11B shows an SDH STM-4 frame or a SONET OC-12 frame.

In FIG. 11A, a transmission speed is 155.52 Mbps, and 9 bytes are arranged for an SOH. In this structure, locations referred to as D1 and D2 bytes are used to assign a wavelength ID. In FIGS. 11A and 11B, the D1 byte is a portion storing a wavelength ID, while the D2 byte stores a serial number (tributary number). Also FIG. 11B is similar except that the transmission speed is faster at 622,08 Mbps, and the number of bytes for the SOH is larger at 36 bytes. Namely, a communication is made by assigning a wavelength ID and a serial number (tributary number) to the D1 and the D2 bytes arranged in the SOH. Each transmission device can obtain a wavelength ID and a serial number by checking the D1 and the D2 bytes of an SOH.

That is, a wavelength ID, which is assigned to an optical transmission device that becomes the starting point of an optical signal, is assigned to the D1 byte, and the number (serial number: tributary number) of optical transmission devices through which the optical signal assigned the wavelength ID passes is assigned to the D2 byte.

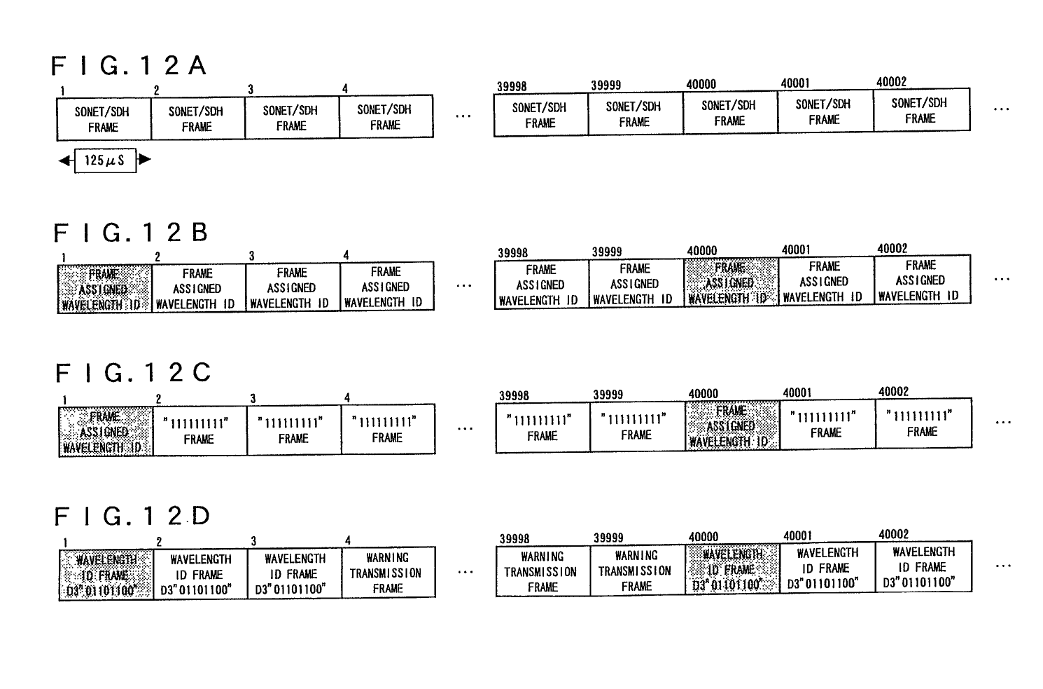

FIGS. 12A through 12D explain how to assign a wavelength ID to the D1 and the D2 bytes.

Normally, SDH or SONET frames are transmitted at a very fast rate. Therefore, if the wavelength IDs of all of frames are stored, and if a transmission device notifies a supervisory control device each time it receives a wavelength ID, the traffic of the supervisory control network becomes very heavy. As a result, even the supervisory control device cannot process transmitted data in some cases.

FIG. 12A explains a SONET or an SDH frame.

In SONET/SDH, one frame is transmitted at 125 microsec. For example, an STM-1/OC-3 frame is 8 bits by 9 rows by 270 columns (19.44 Kbps), and 8,000 frames are transmitted per second at this rate, so that the transmission speed results in 155.52 Mbps.

Also if a wavelength ID is assigned to each frame as shown in FIG. 12B, for example, a transmission device reads the D1 and the D2 bytes of each frame, and extracts the wavelength ID. The transmission device transmits a wavelength ID notification to a supervisory control device, for example, at an interval of 40,000 frames. In FIG. 12B, frames that are notified by the wavelength ID notification are indicated by being shaded.

Or, as shown in FIG. 12C, a wavelength ID is assumed to be assigned, for example, every 40,000 frames. A bit string of “11111111” (0×FF) is assigned to both of the D1 and the D2 bytes of the other frames. A transmission device reads the D1 and the D2 bytes of each frame, and notifies a supervisory control device of only the wavelength ID. Namely, frames in which both of the D1 and the D2 bytes are 0×FF are skipped. In FIG. 12C, the frames to which a wavelength ID is assigned are indicated by being shaded.

Furthermore, as a different method, a wavelength ID is successively assigned to, for example, 3 frames at an interval of 40,000 frames as shown in FIG. 12D. In other cases, the D1 through D3 bytes are used for other use purposes such as a warning transmission, etc. The transmission device notifies the supervisory control device of the D1 and the D2 bytes of the 3 frames, in which the D3 byte is “01101100”, as a wavelength ID. The other frames are processed as the information for a warning transmission. The frames the wavelength IDs of which are notified to the supervisory control device are indicated by being shaded in FIG. 12D.

With the method shown in FIG. 12D, the D1 and D2 bytes can be used also for other use purposes, thereby combining with a different technique using the D1 and D2 bytes.

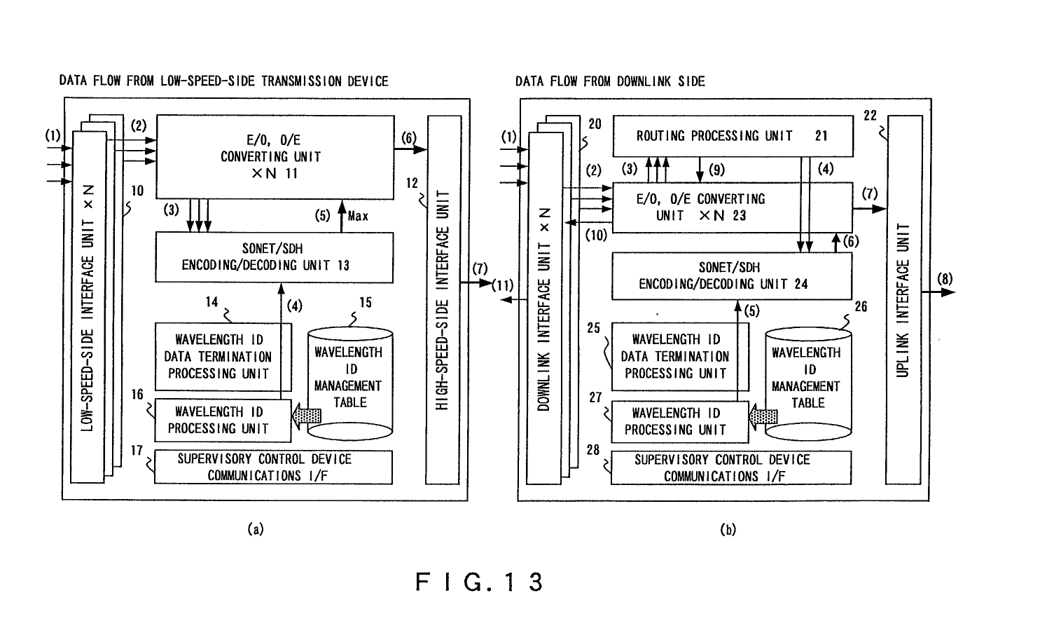

FIG. 13 shows the data flow when a SONET/SDH transmission device (shown in FIG. 13(a)) or a high-speed router (shown in FIG. 13(b)) assigns a wavelength ID.

Note that the same constituent elements as those shown in FIGS. 2 and 3 are denoted with the same reference numerals.

In the SONET/SDH transmission device shown in FIG. 13(a), optical signals (1) accommodated by low-speed-side interface units 10 are transmitted to E/O, O/E converting units 11 (2), and converted into electric signals (3). Their section overheads (SOHs) are checked, and the signals are again multiplexed to frames by a SONET/SDH encoding/decoding unit 13. At this time, a wavelength ID processing unit 16 manages the wavelength ID in a wavelength management table 15 within the device itself. The wavelength ID is assigned to the D1 byte of the SOH within the frame, and “0” is assigned to the D2 byte as a starting point of a transmission (4).

The data to which the wavelength ID is assigned is restored to an optical signal by the E/O, O/E converting units 11 (5), and transmitted to an adjacent optical transmission device via a high-speed-side interface unit 12 (6), (7).

In the high-speed router shown in FIG. 13(b), optical signals (1) accommodated by downlink interface units 20 are transmitted to E/O, O/E converting units 23 (2), converted into electric signals, and transmitted to a routing processing unit 21 (3). The routing processing unit 21 divides the signals into the data for the uplink (4) and the data for the downlink (9). The data for the uplink (4) are put into frames by the SONET/SDH encoding/decoding unit 24. At this time, a wavelength ID processing unit 27 assigns the wavelength ID managed by a wavelength ID management table 26 within the device itself to the D1 byte of the SOH within the frame, and also assigns “0” to the D2 byte as a transmission starting point (5). The data to which the wavelength ID is assigned is restored to an optical signal by the E/O, O/E converting units 23 (7), and transmitted to an adjacent transmission device via an uplink interface unit 22 (8). In the meantime, the data for the downlink are restored to an optical signal by the E/O, O/E converting units 23 (10), and transmitted to an adjacent optical transmission device via the downlink interface units 20 (11).

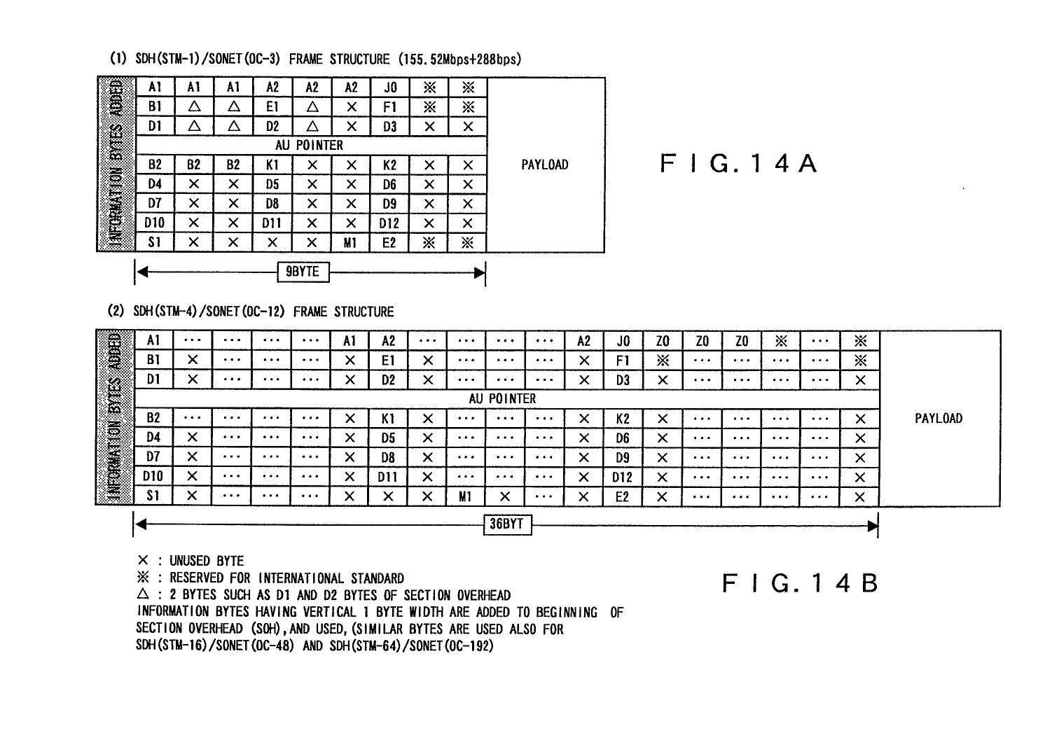

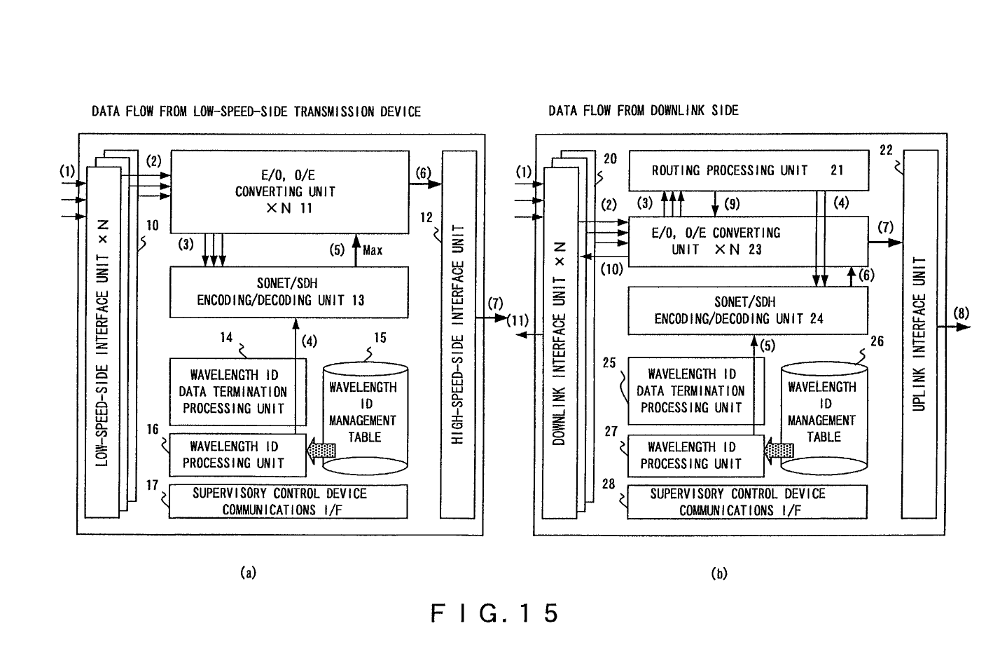

FIGS. 14A, 14B, and 15 explain the method with which information bytes are added to a frame while being transmitted, the wavelength ID that is assigned to and managed by each optical transmission device is buried in the information bytes, and the frame is transmitted.

FIGS. 14A and 14B show the structure of a frame to be transmitted, in which a data area is added to a SONET/SDH frame, and a wavelength ID is assigned to the data area.

FIG. 15 shows the data flows when a SONET/SDH transmission device (shown in FIG. 15(a)) or a high-speed router (shown in FIG. 15(b)) assigns a wavelength ID.

This preferred embodiment refers to the procedure for adding information bytes to a SONET/SDH frame between optical transmission devices, for assigning the wavelength ID that is assigned by a supervisory control device to the added information bytes, and for transmitting the frame by using this portion.

As shown in FIGS. 14A and 14B, the information bytes (shaded portion) for assigning a wavelength ID are added to a frame, and the wavelength ID is transferred by using this portion. The wavelength ID, which is assigned to the optical transmission device that becomes the starting point of an optical signal transmission, is assigned to the byte in the first row, and the number (a serial number or a tributary number) of optical transmission devices, through which the optical signal assigned the wavelength ID passes, is assigned to the byte in the second row.

As shown in FIG. 14A, the vertical information bytes having one byte width are added to the beginning of an STM-1/OC-3 frame. Therefore, the signal speed results in 155.52 Mbps+288 bps. Additionally, as shown in FIG. 14B, the vertical information bytes having one byte width are added to the beginning of an STM-4/OC-12 frame. Accordingly, the signal speed results in 622.08 Mbps+288 bps. As described above, the size of a frame varies by arranging information bytes, leading to a change in signal speeds. If such signal speeds are newly adopted as standards, this preferred embodiment becomes available and common across the world.

FIG. 15 explains the signal flows when a wavelength ID is added to a frame as shown in FIG. 14.

Notice that the same constituent elements as those shown in FIGS. 2 and 3 are denoted with the same reference numerals.

In the SONET/SDH transmission device shown in FIG. 15(a), optical signals (1) accommodated by low-speed-side interface units 10 are transmitted to E/O, O/E converting units 11 (2), and converted into electric signals (3). Then, a SONET/SDH encoding/decoding unit 13 decodes the SONET/SDH frames. Furthermore, the SONET/SDH encoding/decoding unit 13 checks their SOHs, and multiplexes the frames. At this time, a wavelength ID processing unit 16 assigns the wavelength ID, which is managed by the wavelength ID management table 15 within the device itself, to the byte in the first row of expanded information bytes for assigning a wavelength ID to the frame (the first line in the shaded portion in FIG. 14), and also assigns “0” to the byte in the second row as a transmission starting point (4). The data to which the wavelength ID is assigned is again input to the E/O, O/E converting units 11 (5), converted into an optical signal (6), and transmitted to an adjacent optical transmission device via the high-speed-side interface unit 12 (7).

In the high-speed router shown in FIG. 15(b), optical signals (1) accommodated by downlink interface units 20 are transmitted to E/O, O/E converting units 23 (2), and converted into electric signals (3) . Then, a routing processing unit 21 divides the signals into the data for the uplink (4) and the data for the downlink (9). The data for the uplink is then transmitted to a SONET/SDH encoding/decoding unit 24 (4), which encodes the data. At this time, a wavelength ID processing unit 27 assigns the wavelength ID, which is managed by a wavelength ID management table 26 within the device itself, to the byte in the first row of expanded information bytes for assigning a wavelength ID to the frame, and also assigns “0” to the byte in the second row as a transmission starting point (5). The data to which the wavelength ID is assigned (6) is restored to an optical signal by the E/O, O/E converting units 23 (7), and transmitted to an adjacent optical transmission device via an uplink interface unit 22 (8). In the meantime, the data for the downlink (9) is again converted into an optical signal, and transmitted to an adjacent optical transmission device (11) via the downlink interface units 20 (10).

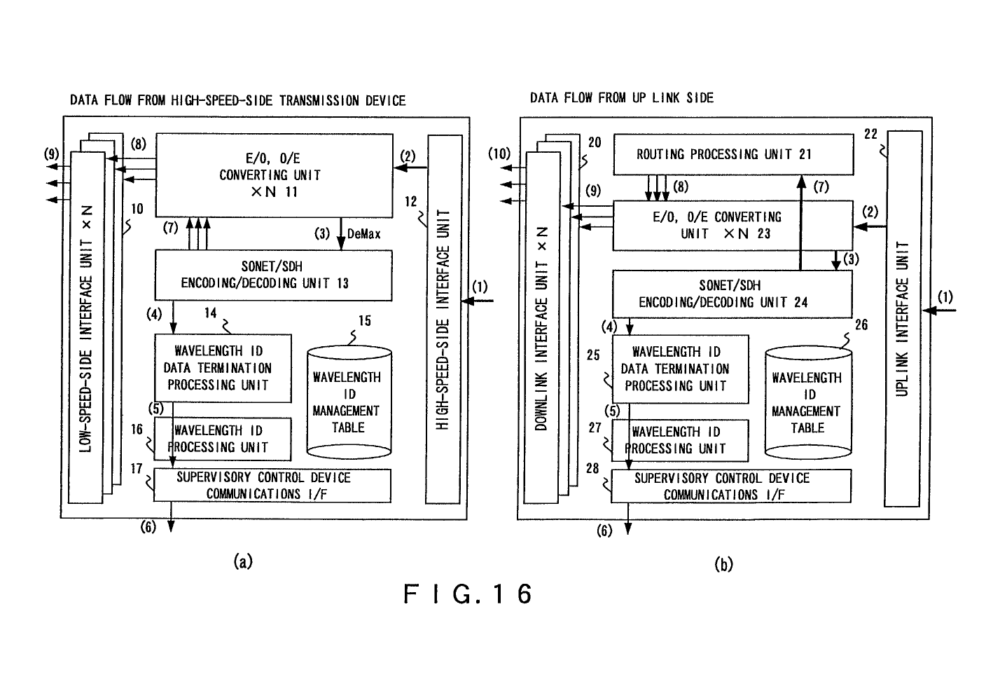

FIG. 16 shows the signal flows when a wavelength ID is transferred in each optical transmission network.

Indicated in these figures are the procedures, in the optical transmission device network shown in FIG. 1, for extracting a wavelength ID buried in a section overhead (SOH) or a wavelength ID buried in the byte added to a SONET/SDH frame with the above described procedure in each wavelength reception device, for notifying a supervisory control device of the extracted information via a supervisory control network, and for assigning a wavelength ID in a data transfer to an adjacent optical transmission device.

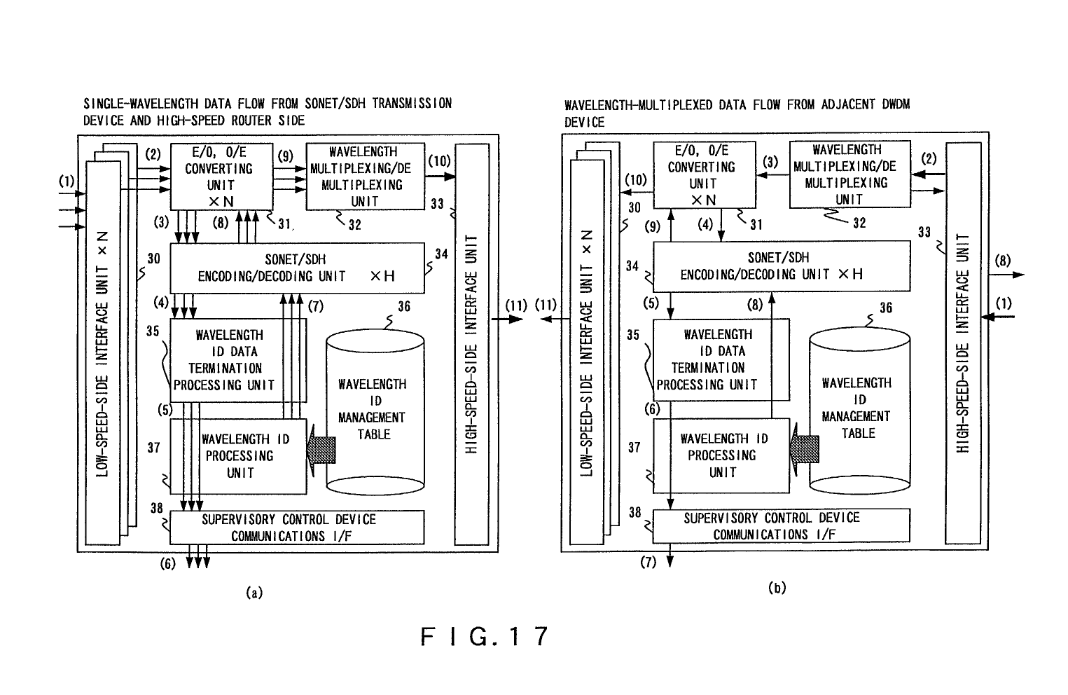

FIG. 16 shows the data flows, the extraction of a wavelength ID, and the notification to a supervisory control device, when a SONET/SDH transmission device or a high-speed router (shown in FIG. 16(a) or 16(b)) receives data to which a wavelength ID is assigned, whereas FIG. 17 shows the data flows, the extraction of a wavelength ID, and the notification to a supervisory control device, when a DWDM device receives data to which a wavelength ID is assigned.

In the SONET/SDH transmission device shown in FIG. 16(a), a high-speed-side interface unit 12 accommodates a multiplexed signal (1). The accommodated signal is transmitted to E/O, O/E converting units 11 (2), and converted into an electric signal (3), which is then input to a SONET/SDH encoding/decoding unit 13. The SONET/SDH encoding/decoding unit 13 checks its SOH and monitors a fault occurrence. A wavelength ID data termination processing unit 14 extracts the wavelength ID buried in the section overhead (SOH) or the wavelength ID buried in the byte added to a SONET/SDH frame from the proper data for which an error occurrence has been monitored(4), and notifies a supervisory control device (6) via a supervisory control device communication I/F 17 (5).

The proper data for which a fault occurrence has been monitored is again encoded by the SONET/SDH encoding/decoding unit 13 (7), again converted into optical signals, and transmitted to an adjacent optical transmission device via low-speed-side interface units 10 (8) and (9).

In the high-speed router shown in FIG. 16(b), an uplink interface unit 22 accommodates an optical signal (1). The accommodated signal is converted into an electric signal (3) by E/O, O/E converting units 23. The SONET/SDH encoding/decoding unit 24 checks its SOH, and monitors a fault occurrence. A wavelength ID data termination processing unit 25 extracts the wavelength ID buried in the section overhead (SOH) or the wavelength ID buried in the byte added to a SONET/SDH frame from the proper data for which an error occurrence has been monitored (4), and notifies a supervisory control device (6) via a supervisory control device communication I/F 28 (5).

The signal from which the wavelength ID is extracted is routed to a downlink side signal by the routing processing unit. The downlink side data is converted into optical signals (8), and transmitted to an adjacent optical transmission device (10) via downlink interface units 20 (9).

In the DWDM device shown in FIG. 17, optical signals from a SONET/SDH transmission device and a high-speed router are accommodated by low-speed-side interface units 30 (1). The accommodated optical signals are converted into electric signals by E/O, O/E converting units 31 (2). Then, a SONET/SDH encoding/decoding unit 34 checks their SOHs and monitors a fault occurrence (3).

A wavelength ID data termination processing unit 35 extracts the wavelength ID buried in the section overhead (SOH) or the wavelength ID buried in the byte added to a SONET/SDH frame from the proper data for which an error occurrence has been monitored (4), and notifies a supervisory control device (6) via a supervisory control device communication I/F 38 (5).

Thereafter, the SONET/SDH encoding/decoding unit 34 decodes the frame from which the wavelength ID is extracted. A wavelength ID processing unit 37 assings the wavelength ID managed in a wavelength ID management table 36 within the device itself, and the value (a serial number or a tributary number) obtained by counting up the number of passed transmission devices (7). The frames are converted into optical signals by the E/O, O/E converting units 31 (8). The optical signals are then multiplexed by a wavelength multiplexing/demultiplexing unit 32 (9), and transmitted to an adjacent WDM device (11) via a high-speed-side interface unit 33 (10).

In the meantime, as shown in FIG. 17(b), an optical signal (1) from an adjacent WDM device, which is accommodated by the high-speed-side interface 33 (2), is demultiplexed by the wavelength multiplexing/demultiplexing unit 32, and converted into electric signals by the E/O, O/E converting units 31 (4). The SONET/SDH encoding/decoding unit 34 checks their SOHs, and monitors a fault occurrence.

The wavelength ID data termination processing unit 35 extracts the wavelength ID buried in the section overhead (SOH) or the wavelength ID buried in the byte added to a SONET/SDH frame from the proper data for which an error occurrence has been monitored (5) and (6), and notifies the supervisory control device via the supervisory control device communication I/F 38 (7). Then, the SONET/SDH encoding/decoding unit 34 encodes the frame from which the wavelength ID is extracted. The wavelength ID processing unit 37 assigns the wavelength ID managed in the wavelength ID management table 36 within the device itself, and the value (a serial number or a tributary number) obtained by counting up the number of passed transmission devices (8). The E/O, O/E converting units 31 convert the frames into an optical signal (9), which is then transmitted to an adjacent optical transmission device (11) via the low-speed-side interface units 30 (10). In the meantime, the signal, which is to be transferred unchanged to the adjacent WDM device, in the optical signal accommodated by the high-speed-side interface unit 33 is input to the wavelength multiplexing/demultiplexing unit 32. Then, the signal is again input to the high-speed-side interface unit 33 unchanged, and transferred to the adjacent WDM device (8).

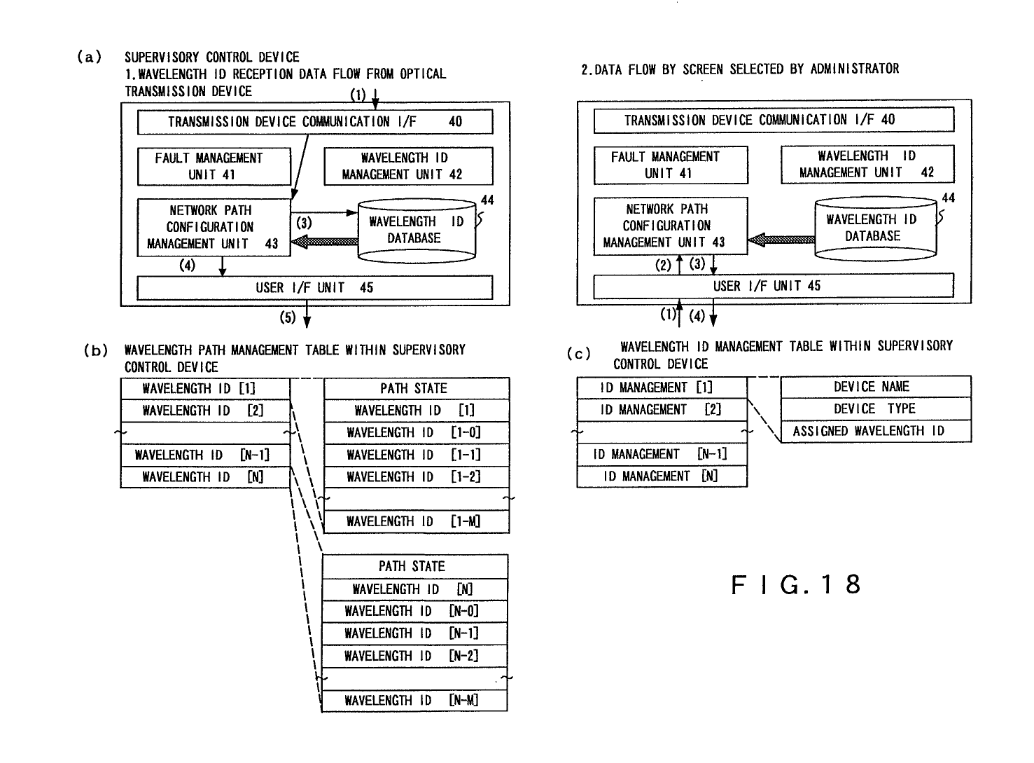

FIGS. 18 through 20 exemplify the reception of a wavelength ID, the procedure for managing wavelength IDs, and management screens in a supervisory control device.

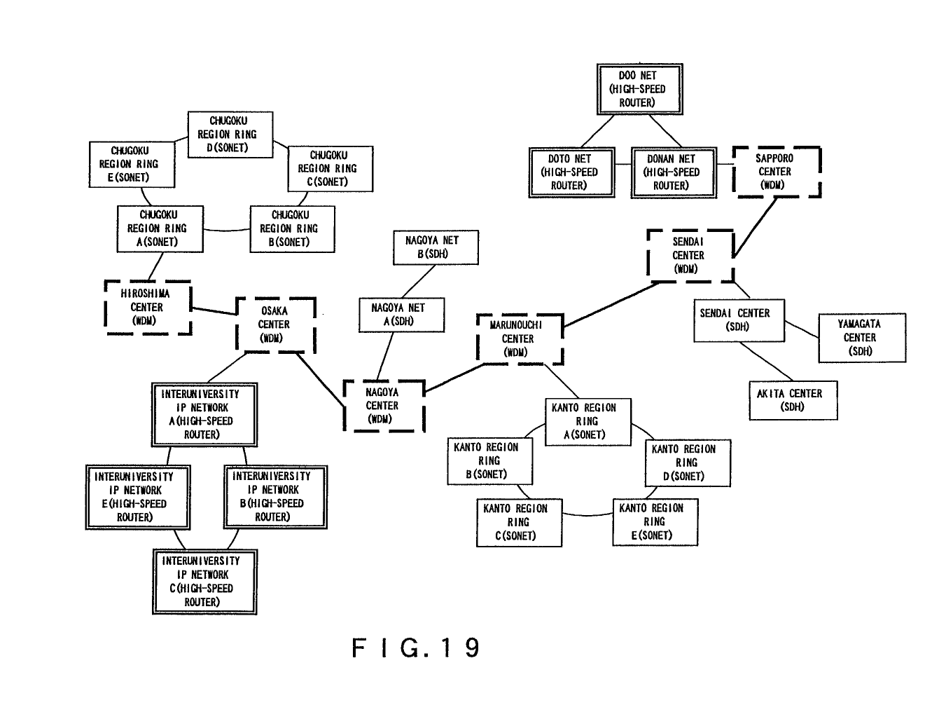

FIG. 19 exemplifies the network configuration screen on a supervisory control device at a normal time, and shows the wavelength paths of optical transmission devices (SONET/SDH transmission devices and high-speed routers).

This screen is a screen for representing on which route a wavelength transmitted from a certain optical transmission device passes, and to which optical transmission device the wavelength is transmitted. FIG. 19 shows a GUI interface that is displayed on the monitor of a workstation, etc. being a supervisory control device, and makes an administrator learn on which route a fault occurs at first sight.

FIG. 18 shows the state where the wavelength ID information assigned to an optical transmission signal is notified from each wavelength reception device to a supervisory control device, and managed in the management tables (shown in FIGS. 18(b) and 18(c)) within the supervisory control device.

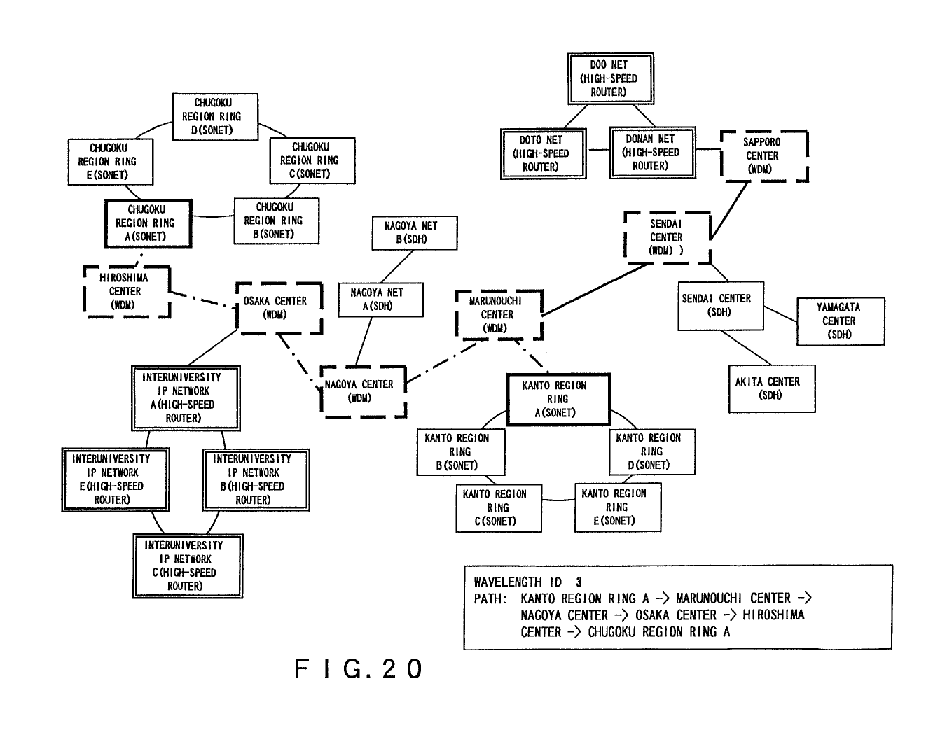

FIG. 20 shows an example where the path of a wavelength ID selected from the internal wavelength path management table (shown in FIG. 18(b)), which is managed by the supervisory control device in a centralized manner, is visually displayed on the GUI of the supervisory control device.

As shown in FIG. 18, the wavelength IDs notified from respective optical transmission devices to the supervisory control device are managed, and path information are visually displayed on the screen of the supervisory control device according to the managed information. The supervisory control device shown in FIG. 18(a) receives a wavelength ID notification (1) from each optical transmission device (a SONET/SDH transmission device, a high-speed router, or a WDM device) via a transmission device communication I/F 40. The received wavelength ID is passed to a network path configuration management unit 43 (2), and managed in wavelength ID units in the path management table (shown FIG. 18(b)) (3).

Furthermore, the screen of the network configuration shown in FIG. 19 is configured from this information, and displayed on the monitor (5) via a user I/F unit 45 (4). By selecting an optical transmission device on the monitor of the supervisory control device as shown in FIG. 18A as “2 the data flow by an administrator's selection on the screen”, the name of the optical transmission device is notified to the network path configuration management unit 43 (2). The network path configuration management unit 43 references the path management table (shown in FIG. 18(b)) and the wavelength management table (shown in FIG. 18(c)), and configures the screen shown in FIG. 20, so that the optical path from the selected device is displayed on the monitor (the selected path is indicated by a dotted line in FIG. 20) (4) via the user I/F unit 45 (3).

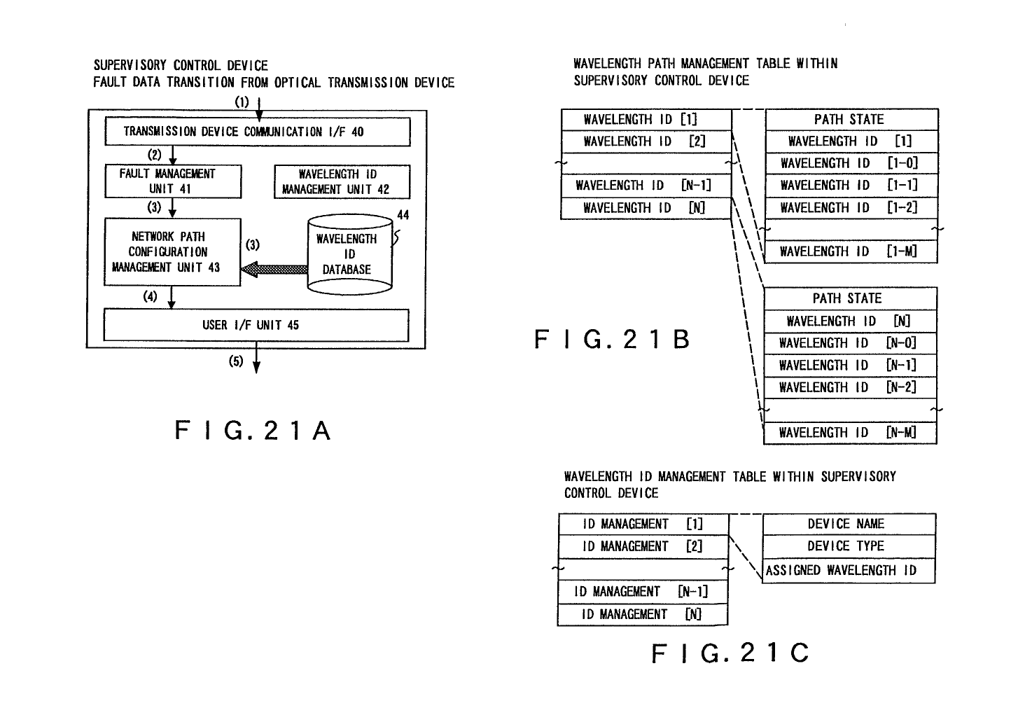

FIGS. 21A through 24 explain the procedure for identifying a point at which a fault occurs from the warning information notified from an optical transmission device when the fault arises, and the process for identifying the path on which the fault occurs.

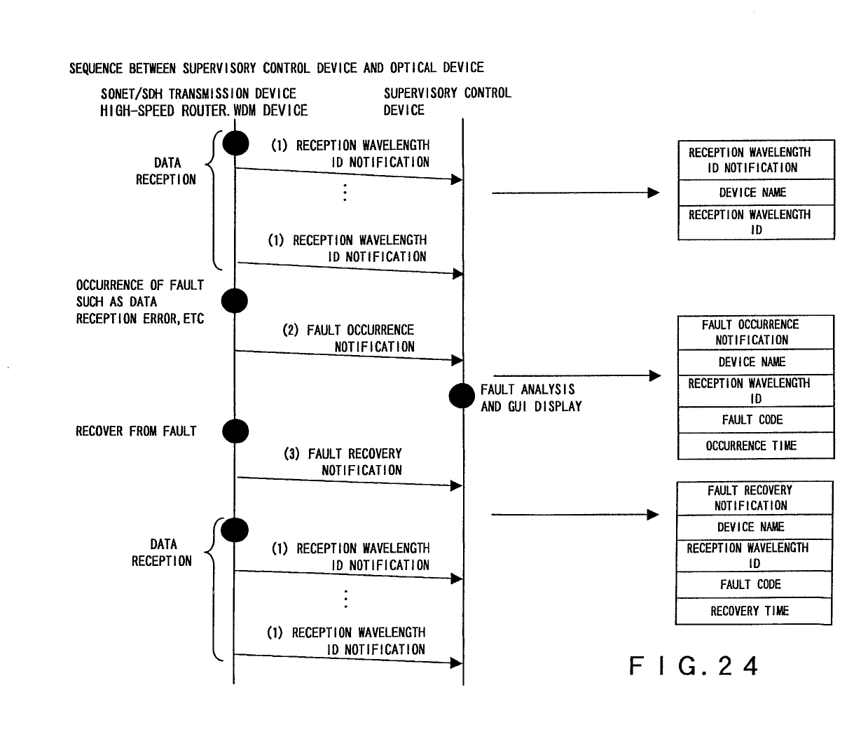

FIG. 24 shows the sequence from when a fault occurs between an optical transmission device and a supervisory control terminal during operations, till the fault is recovered. Normally, an optical transmission device transmits a reception wavelength ID notification ((1) of FIG. 24) to a supervisory control device upon receipt of data to which a wavelength ID is assigned. When a certain optical transmission device detects a fault, this device transmits a fault occurrence notification ((2) of FIG. 24) to the supervisory control device.

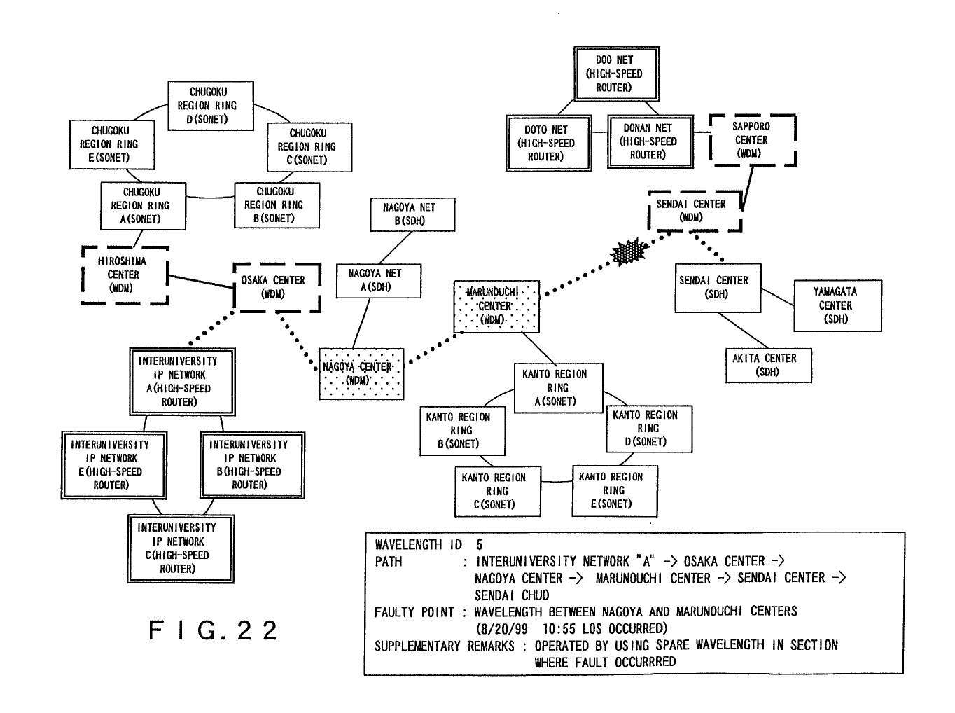

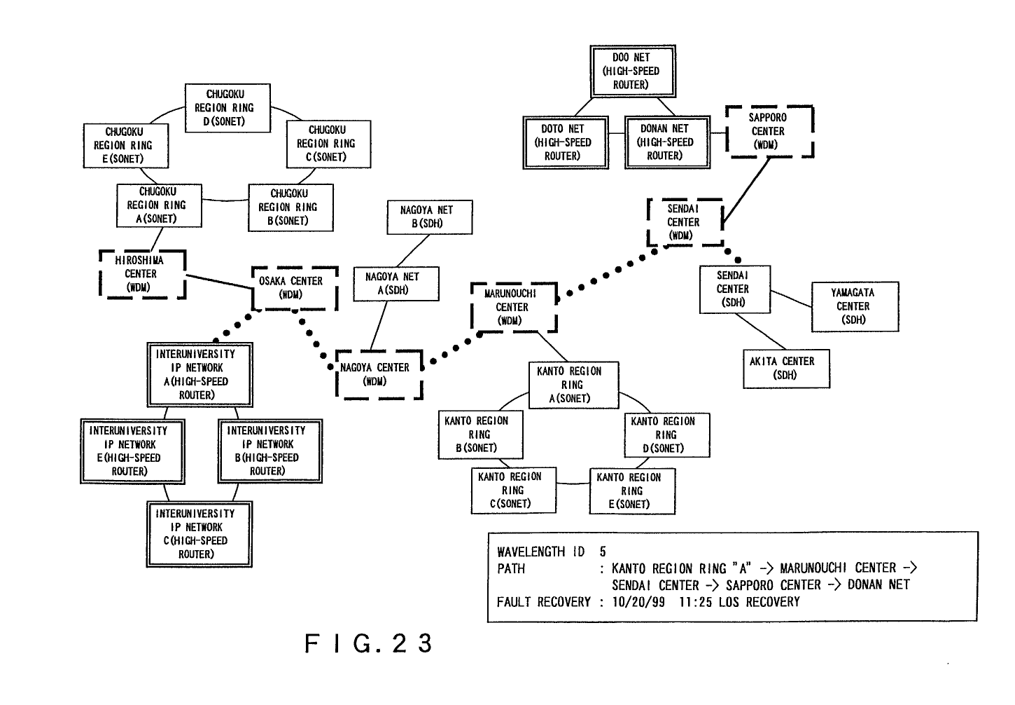

Furthermore, the fault is recovered, the optical transmission device transmits a fault recovery notification ((3) of FIG. 24). FIGS. 21A through 21C show the flow for displaying the transmitted fault occurrence notification ((2) of FIG. 24) on the management screen. FIG. 22 exemplifies the screen of the supervisory control device when a fault occurs. FIG. 23 exemplifies the screen of the supervisory control device when the fault is recovered.

The data processing within the supervisory control device is performed as shown in FIGS. 21A through 21C.

Namely, the supervisory control device receives a fault occurrence notification via a transmission device communication I/F 40 when a fault occurs (1), and notifies a fault management unit 41 (2). The fault management unit 41 notifies a network path configuration management unit 43 of the wavelength ID based on the information (3). The network path configuration management unit 43 references the path management table (shown in FIG. 21B) and the wavelength ID management table (shown in FIG. 21C), configures the screen shown in FIG. 22, and displays the point at which and the path on which the fault occurs on the monitor (5) via the user I/F unit 45 (4).

When the fault is recovered, the supervisory control device receives a fault recovery notification via a transmission device communication I/F (1), and notifies the fault management unit 41 (2). The fault management unit 41 notifies the network path configuration management unit 43 of the wavelength ID based on the information (3). The network path configuration management unit 43 references the path management table (shown in FIG. 21B) and the wavelength ID management table (shown in FIG. 21C) , configures the screen shown in FIG. 23, and recovers the point at which and the path on which the fault occurs on the monitor (5) via the user I/F unit 45 (4).

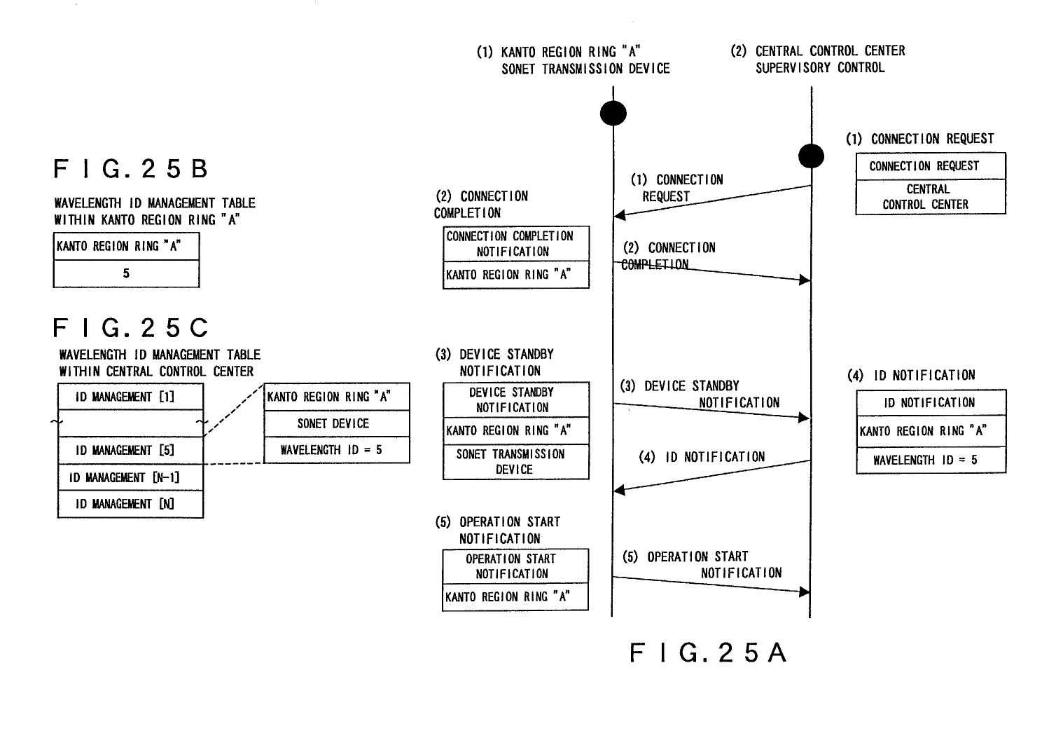

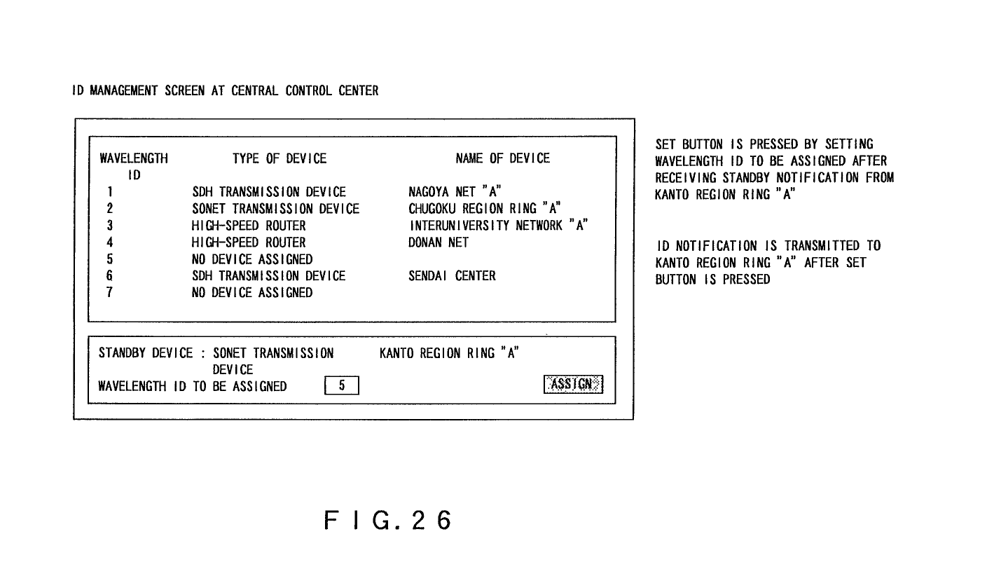

FIGS. 25A through 25C and 26 explain a specific example of the process assigning a wavelength ID.

Explanation is provided by taking as an example a Kanto region ring “A” (SONET transmission device) and a central control center (supervisory control device). An administrator makes initial settings (configuration within the device, operation mode, supervisory network settings, etc.) for the Kanto region ring “A” by using an initial maintenance terminal on site. A network administrator of the central control center manages the paths with the supervisory control device via the supervisory network.

As shown in the sequence of FIG. 25A, a connection request (1) is first issued from the central control center to the target Kanto region ring “A”. The Kanto region ring “A” returns a connection completion notification (2) in response to this request (If the initial settings for the Kanto region ring “A” has not completed when the connection request is issued, an unable-to-connect notification is returned). As a result, a connection is established between the central control center and the Kanto region ring “A”, and subsequent communications are made via the connection. After the connection is established, the Kanto region ring “A” notifies the central control center of the name of the device (Kanto region ring “A”) and the type of the device (SONET transmission device) with a device standby notification (3). The notified information are managed in the management table (shown in FIG. 25C) within the central control center. Thereafter, the network administrator assigns a wavelength ID on the screen shown in FIG. 26. The information that are currently managed by the management table are displayed on the screen shown in FIG. 26, and an empty ID is selected from the displayed information by pressing an assign button. As a result, an assigned wavelength ID “5” is notified with an ID notification (4) from the central control center to the Kanto region ring “A”. The Kanto region ring “A” manages the assigned wavelength ID “5” by using the management table (shown in FIG. 25B) within the device, and transmits an operation start notification (5) to the central control center, so that the operations are started.

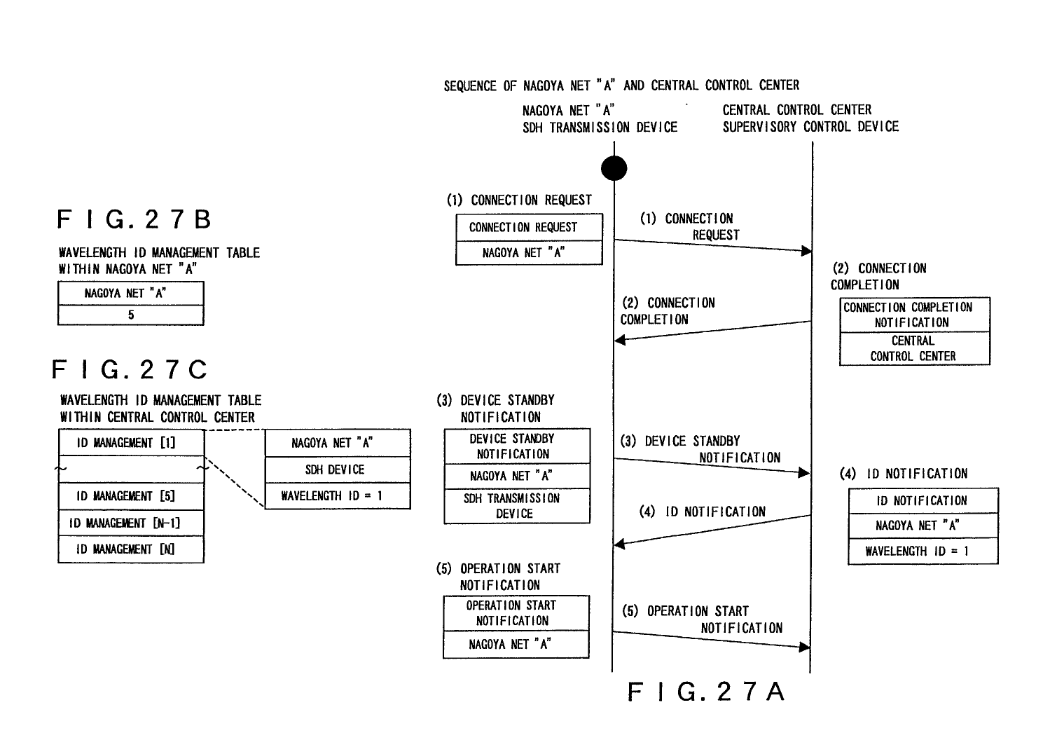

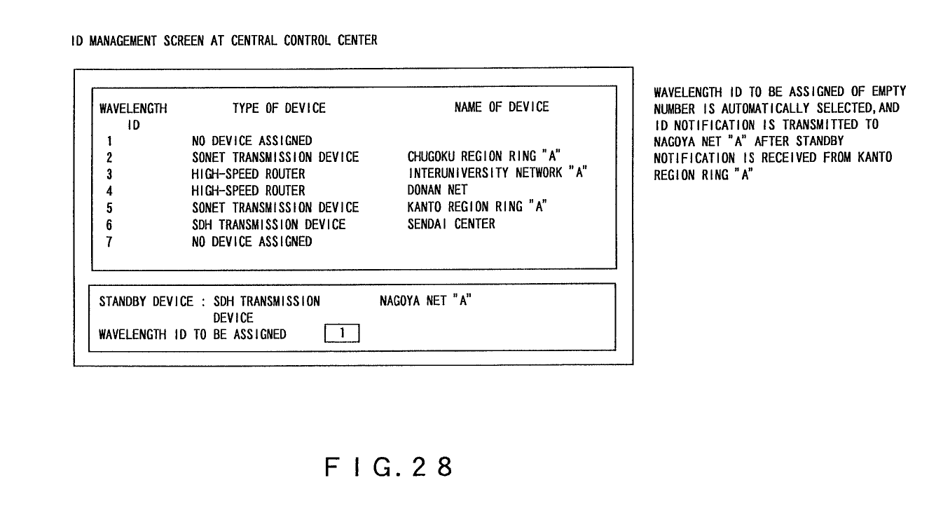

FIGS. 27A through 27C and 28 explain a specific example of the process automatically assigning a wavelength ID.

Explanation is provided by taking as an example a Nagoya net “A” (SDH transmission device) and a central control center (supervisory control device) in an optical transmission device network. An administrator makes initial settings (configuration within the device, operation mode, supervisory network settings, etc.) for the Nagoya net “A” by using an initial maintenance terminal on site. The supervisory control device automatically manages paths via the supervisory network.

After the initial settings are made, the Nagoya net “A” first issues a connection request (1) to the central control center. The central control center returns a connection completion notification (2) in response to the connection request. As a result, a connection is established between the central control center and the Nagoya net “A”, and subsequent communications are made via this connection.

After the connection is established, the Nagoya net “A” notifies the central control center of the name of the device (Nagoya net “A”) and the type of the device (SDH transmission device) with a device standby notification (3). The notified information are managed in the management table (shown in FIG. 27C) within the central control center. Thereafter, an empty ID is automatically searched in the information that are currently managed by the management table within the central control center, and an assigned wavelength ID “1” is notified to the Nagoya net “A” with an ID notification (4). The assignment state is displayed on the screen shown in FIG. 28. The Nagoya net “A” manages the assigned wavelength ID by using the management table (shown in FIG. 27B) within the device, and transmits an operation start notification (5) to the central control center. As a result, the operations are started.

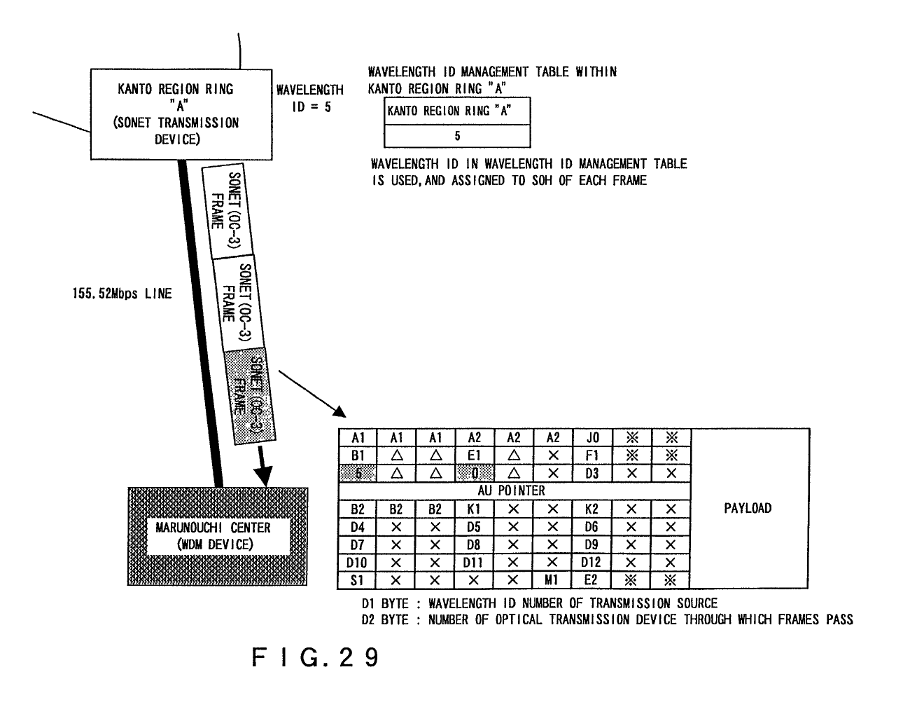

FIG. 29 shows a specific example of the process assigning a wavelength ID in an optical transmission device network.

A transmission path of 155.52 Mbps is established between a Kanto region ring “A” (SONET transmission device) and a Marunouchi center (WDM device). SONET (OC-3) frames are transmitted over this path. The Kanto region ring “A” assigns a wavelength ID to the SONET (OC-3) frames, and transmits the frames. Namely, the Kanto region ring “A” respectively assigns a wavelength ID “5” managed within the device, and the number “0” of devices through which the frames pass as a transmission starting point device to the D1 and the D2 bytes of the section overhead (SOH) within each frame.

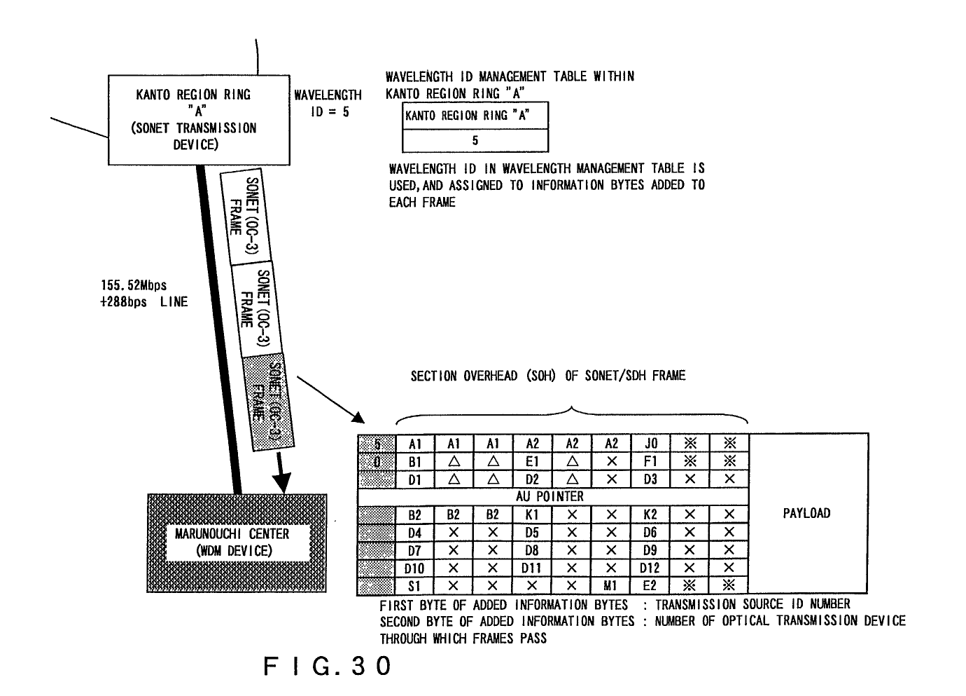

FIG. 30 shows another specific example of the process assigning a wavelength ID in the optical transmission device network.

A transmission path of 155.5 Mbps+288 bps is established between a Kanto region ring “A” (SONET transmission device) and a Marunouchi center (WDM device). Additional information (288 Kbps) is added to each SONET (OC-3) frame and transmitted over the path. The Kanto region ring “A” assigns a wavelength ID to the information added to the SONET (OC-3) frame, and transmits the frame. The Kanto region ring “A” adds the information bytes having a 1-byte width to the beginning of the section overhead (SOH) of each frame, respectively assigns the wavelength ID “5” managed within the device and the number “0” of optical transmission devices through which the frames pass to the added bytes, and transmits the frames.

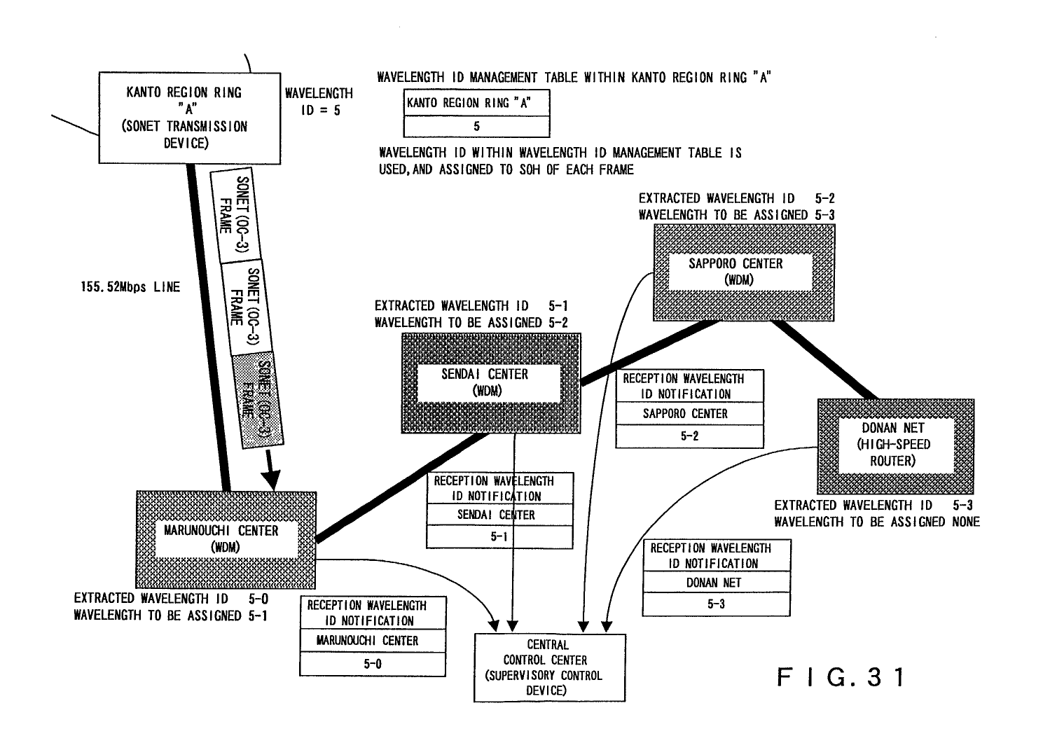

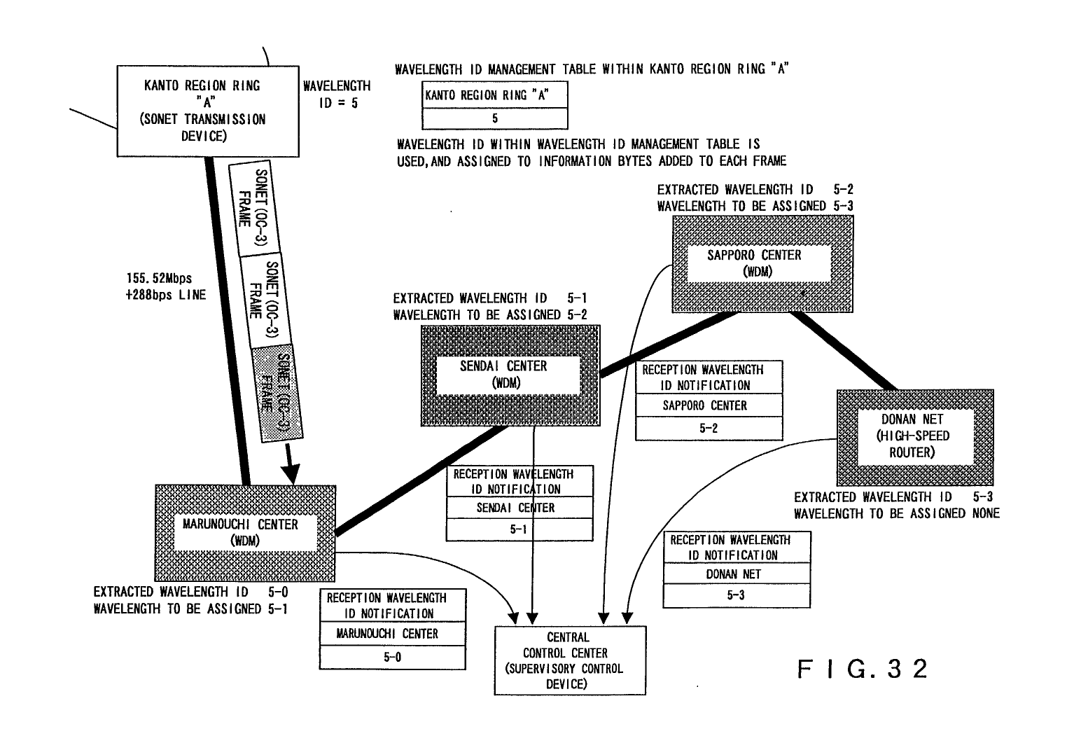

FIGS. 31 and 32 show a specific example of the process transferring a wavelength ID in an optical transmission device network.

Provided here is an example where a Kanto region ring “A” transmits to a Donan net the wavelength ID assigned to the SOH (shown in FIG. 31) within a SONET frame or the information bytes added to a SONET frame (shown in FIG. 32). The transmission data to which the wavelength ID is assigned by the Kanto region Ring “A” is transferred to the Marunouchi center. The Marunouchi center extracts the assigned wavelength ID “5-0” from the reception data, and notifies the central control center of this information as a reception wavelength ID notification. The Marunouchi center again puts the reception data into frames, and transfers the frames to a Sendai center. At this time, the Marunouchi center assigns an ID “5” as a wavelength ID and the number “1” of optical transmission devices through which the frames pass, and transmits the frames. Similarly, the Sendai center extracts the assigned wavelength ID “5-1” from the reception data, and notifies the central control center of this information as a reception wavelength ID notification. The Sendai center again puts the reception data into frames, and transfers the frames to a Sapporo center. At this time, the Sendai center assigns an ID “5” as a wavelength ID, and the number “2” of optical transmission frames through which the frames pass, and transmits the frames. Similarly, the Sapporo center extracts the assigned wavelength ID “5-2” from the reception data, and notifies the central control center of the extracted information as a reception wavelength ID. The Sapporo center again puts the reception data into frames, and transfers the frames to a Donan net. At this time, the Sapporo center assigns an ID “5” as a wavelength ID, and the number “3” of optical transmission devices through which the frames pass, and transmits the frames. Also the Sapporo center extracts the assigned wavelength ID “5-3” from the reception data, and notifies the central control center of the extracted information as a reception wavelength ID notification.

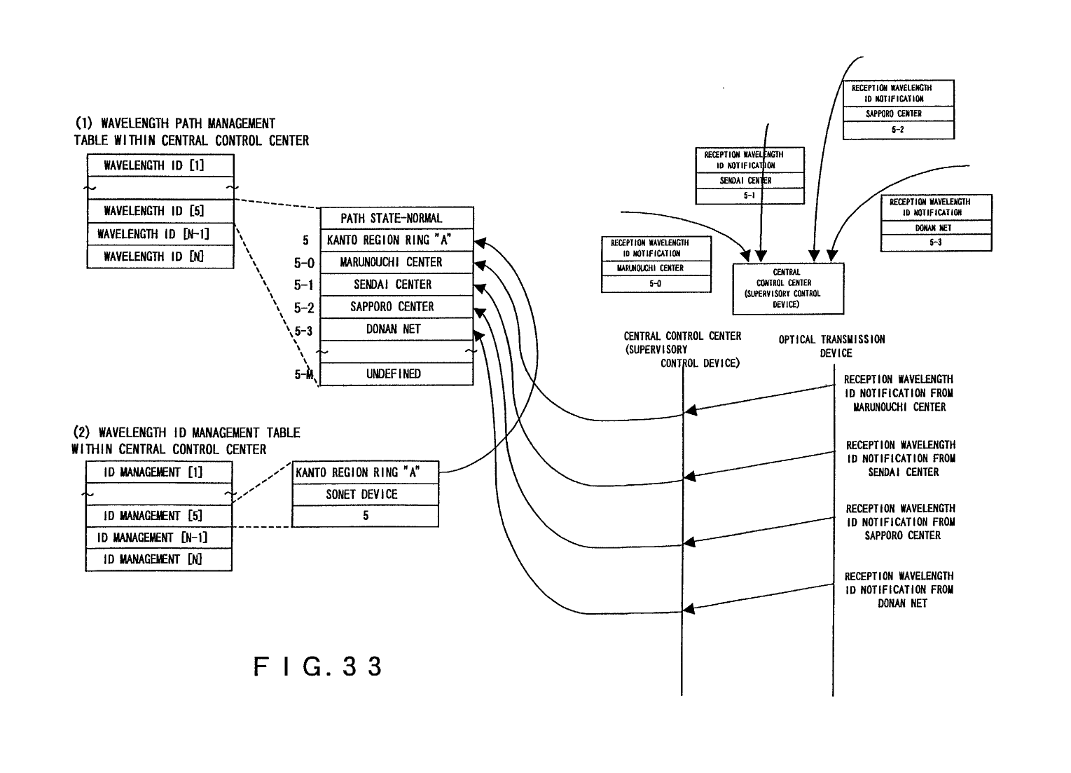

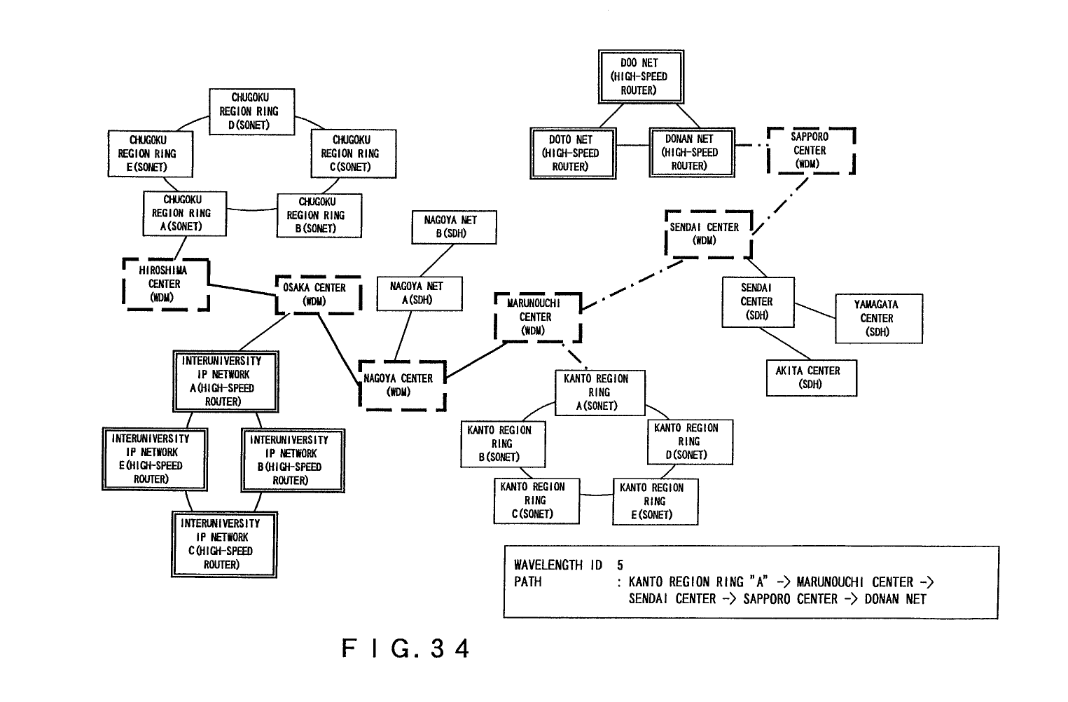

FIGS. 33 and 34 show a specific example of the procedure for managing a communications path in a central control center.

A supervisory control device at the central control center manages paths based on the reception wavelength ID notification received from each optical transmission device with the following procedure. A wavelength path management table ((1) of FIG. 33) and a wavelength ID management table ((2) of FIG. 33) are internally managed as databases at the central control center. The wavelength ID management table (2) is a table for managing the value of the wavelength ID assigned to each optical transmission device, as described above. When a network is operated, the information of corresponding optical transmission devices are already stored in the wavelength ID table. In this example, the device corresponding to the wavelength ID “5” is a Kanto region ring “A” (SONET transmission device).

The wavelength path management table (1) is a table for managing the paths of respective wavelength IDs. In the initial state, the name of the device managed in the wavelength ID management table is stored for the path starting point portion ID “5” in the table which corresponds to each wavelength ID. When a data transmission is started, a reception wavelength ID notification is transmitted from each optical transmission device. Upon receipt of the reception wavelength ID notification “5-0” from the Marunouchi center, the name of the device (Marunouchi center) is stored for the ID “5-0” of the wavelength ID “5” upon receipt of the reception wavelength ID notification “5-0” from the Marunouchi center. Similarly, upon receipt of the reception wavelength ID notification “5-1” from the Sendai center, the name of the device (Sendai center) is stored for the ID “5-1” of the wavelength ID “5”. Likewise, upon receipt of the reception wavelength ID notification “5-2” from the Sapporo center, the name of the device (Sapporo center) is stored for the ID “5-2” of the wavelength ID “5”. In a similar manner, upon receipt of the reception wavelength ID notification “5-3” from the Donan net, the name of the device (Donan net) is stored for the ID “5-3 of the wavelength ID “5””.

In this way, the paths of the wavelength ID “5” are settled. The central control center receives a reception wavelength notification from each optical transmission device, stores the ID in the database, and manages each path. If the Kanto region ring “A” is selected on the screen of the central control center when the path is verified, the path of the corresponding wavelength ID “5” is made visible on the screen (shown in FIG. 34) based on the wavelength path management table (1). At the same time, the wavelength ID and the path information are displayed on the screen.

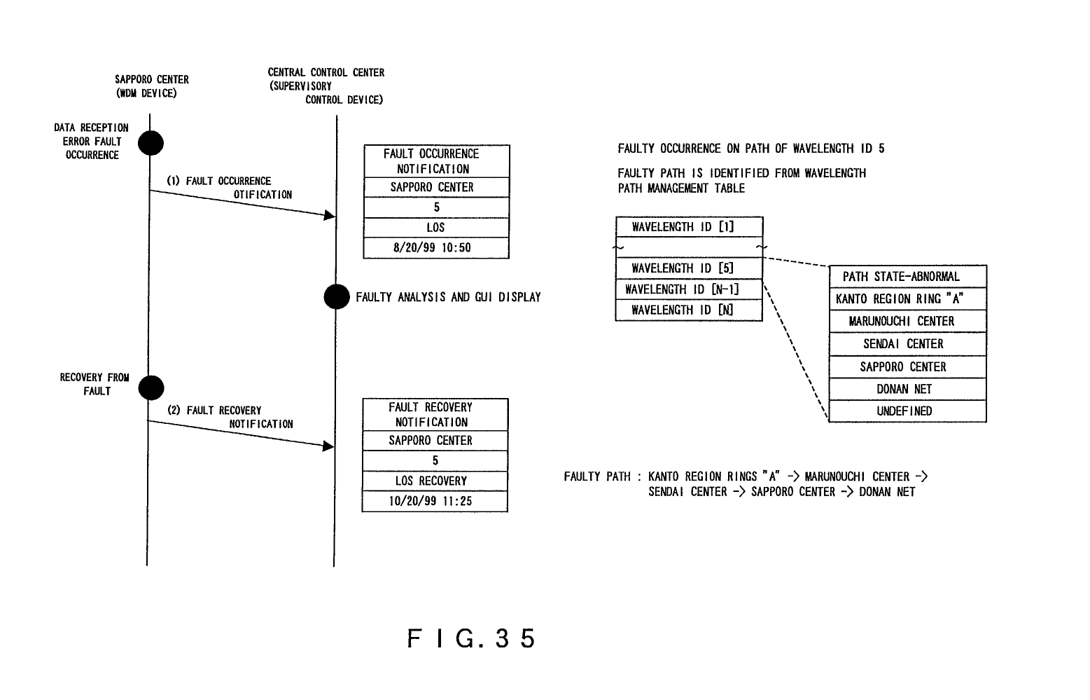

FIGS. 35 through 37 explain a specific example of a fault management unit within a central control center.

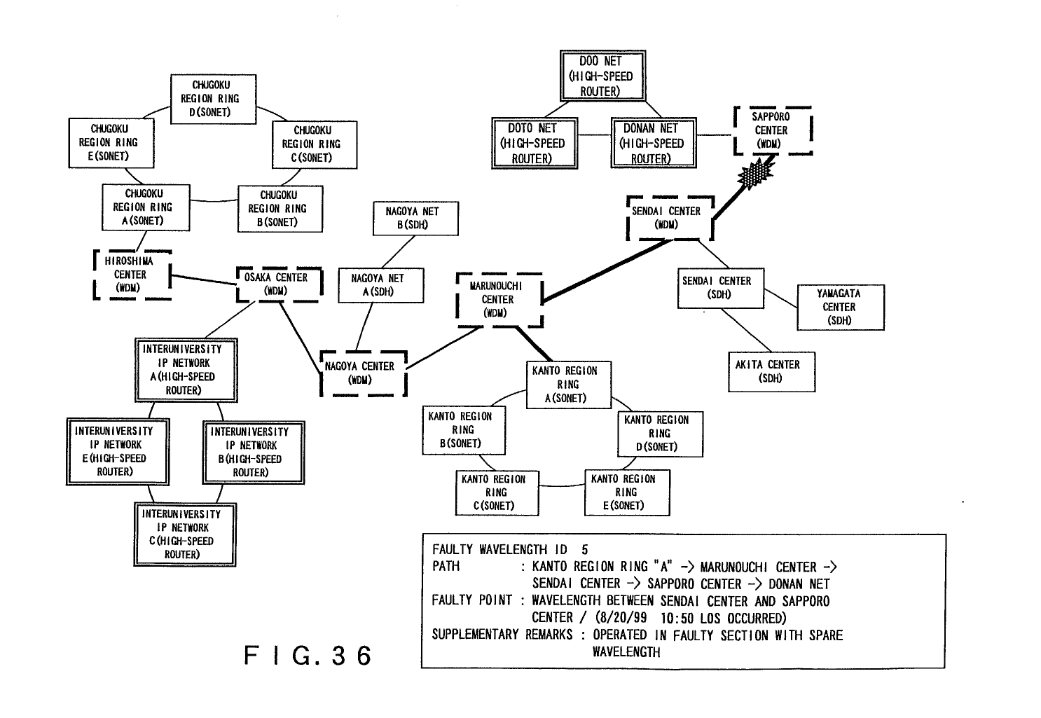

Each optical transmission device checks the section overhead (SOH) (or the added information bytes) of each SONET/SDH frame, and monitors a fault occurrence. If the Sapporo center detects an error such as a data reception error on the transmission path of the wavelength ID “5” from the Kanto region ring “A” to the Donan net, it transmits a fault occurrence notification (1) to the central control center. With the fault occurrence notification (1), the name of the device detecting the fault occurrence (Sapporo center), the wavelength ID “5” on which the fault occurs, the content of the fault (LOS: Loss Of Signal), a time at which the fault occurs (10:50 on Aug. 20, 1999) are notified. The central control center, which receives the fault occurrence notification (1), identifies the path (from the Kanto region ring “A” to the Marunouchi center to the Sendai center to the Sapporo center to the Donan net) of the wavelength ID “5” from the notified wavelength ID “5” based on the wavelength path management table, and displays on the screen (as shown in FIG. 36) the section from which the fault occurrence is detected, the path on which the fault occurs, and the wavelength ID “5” on which the fault occurs, the path (from the Kanto region ring “A” to the Marunouchi center to the Sendai center to the Sapporo center to the Donan net), the point at which the fault occurs (the wavelength between the Sendai center and the Sapporo center (an LOS occurs at 10:50 on Aug. 20, 1999)), and supplementary information (operated with a spare wavelength in the section in which the fault occurs), which are obtained from the respective information. Note that the point at which the fault occurs is detectable with an existing technique. Furthermore, if the Sapporo center detects a fault recovery, it transmits a fault recovery notification (2) to the central control center.

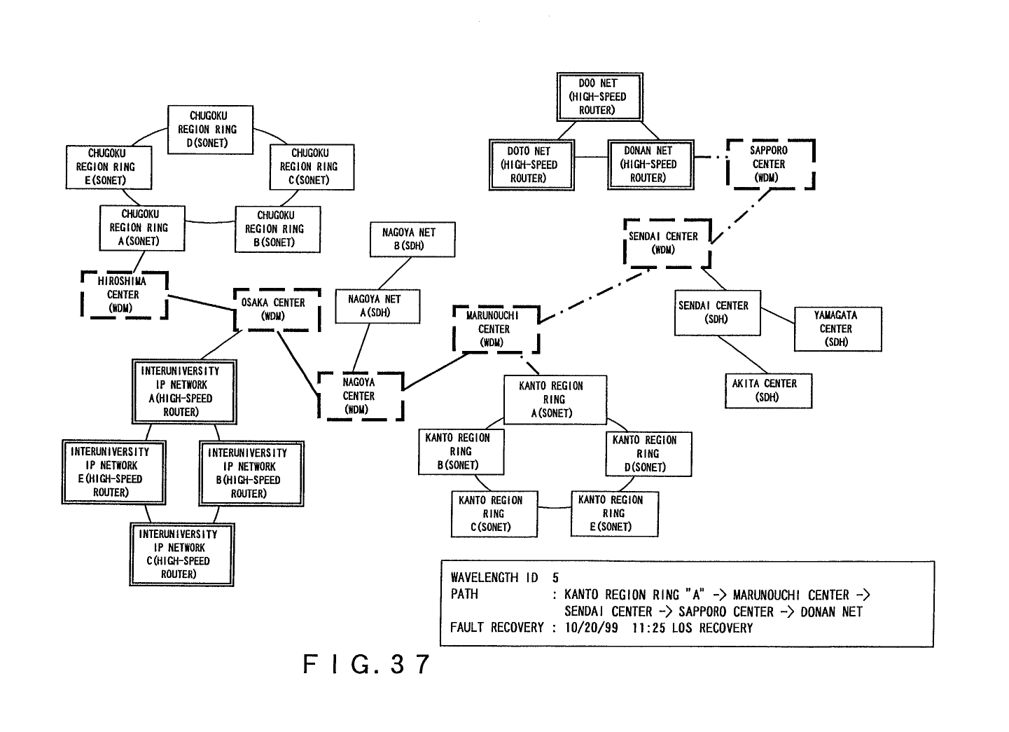

With the fault recovery notification (2), the name of the device which detected the fault recovery (Sapporo center), the recovered wavelength ID “5”, the content of the recovery (LOS recovery), and the recovery time (11:25 on Oct. 20, 1999) are notified. The central control center, which receives the fault recovery notification (2), identifies the path of the wavelength ID “5” (from the Kanto region ring “A” to the Marunouchi center to the Sendai center to the Sapporo center to the Donan net) from the notified wavelength ID “5” based on the wavelength path management table, and displays on the screen (as shown in FIG. 37) the recovered wavelength ID “5”, the path ((from the the Kanto region ring “A” to the Marunouchi center to the Sendai center to the Sapporo center to the Donan net), and the content of the recovery (LOS recovery at 11:25 on Oct. 20, 1999), which are obtained from each information.

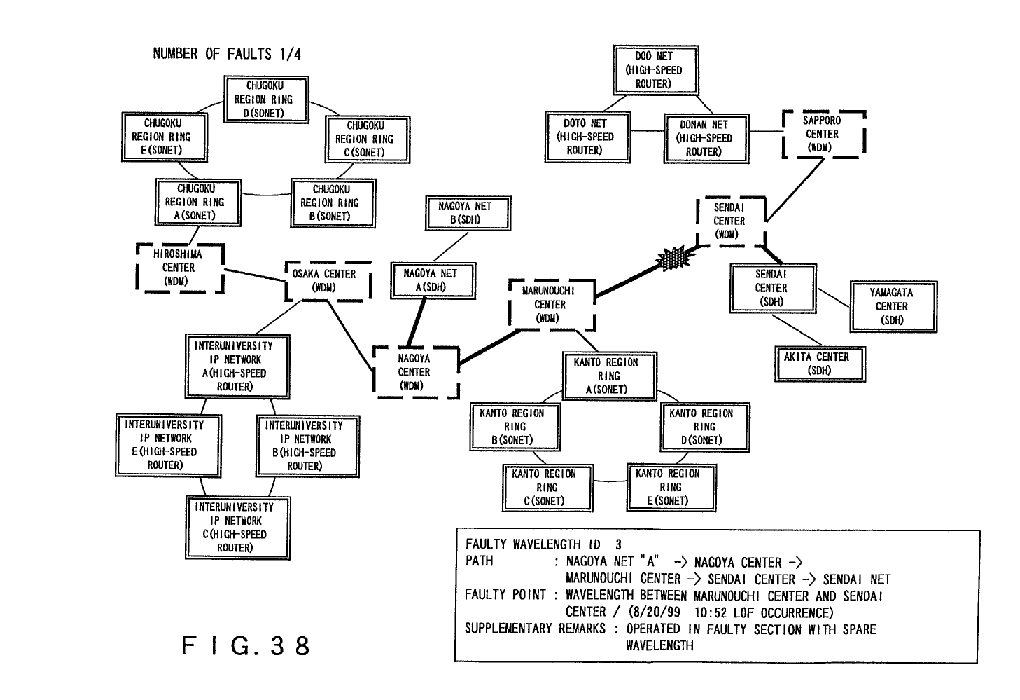

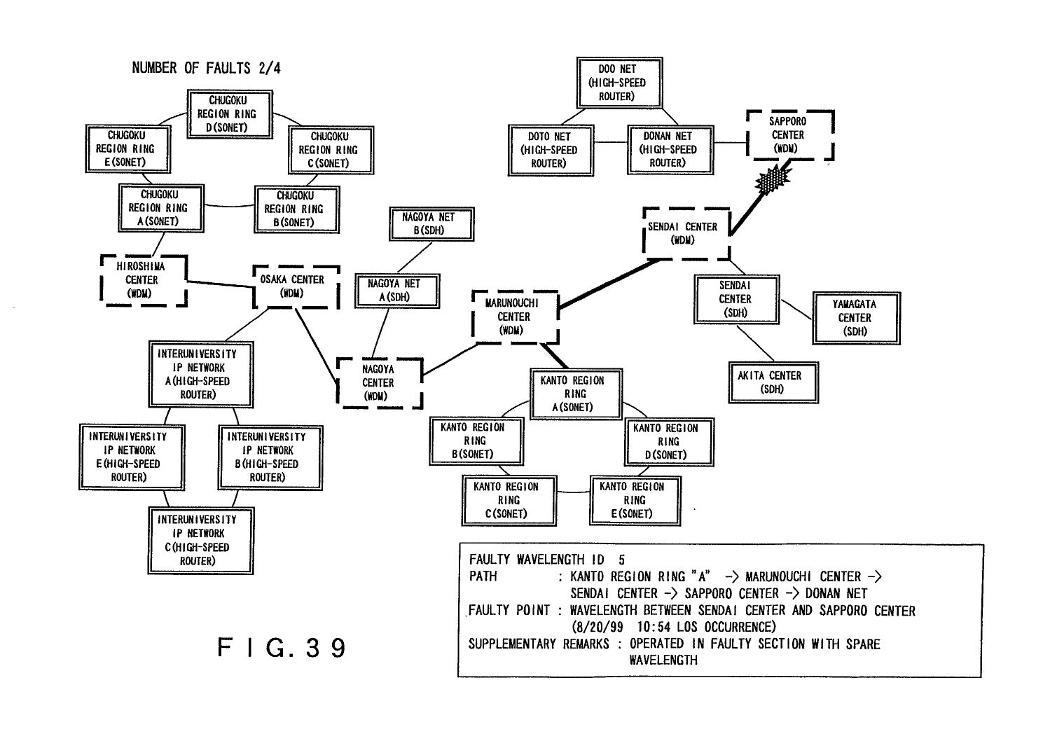

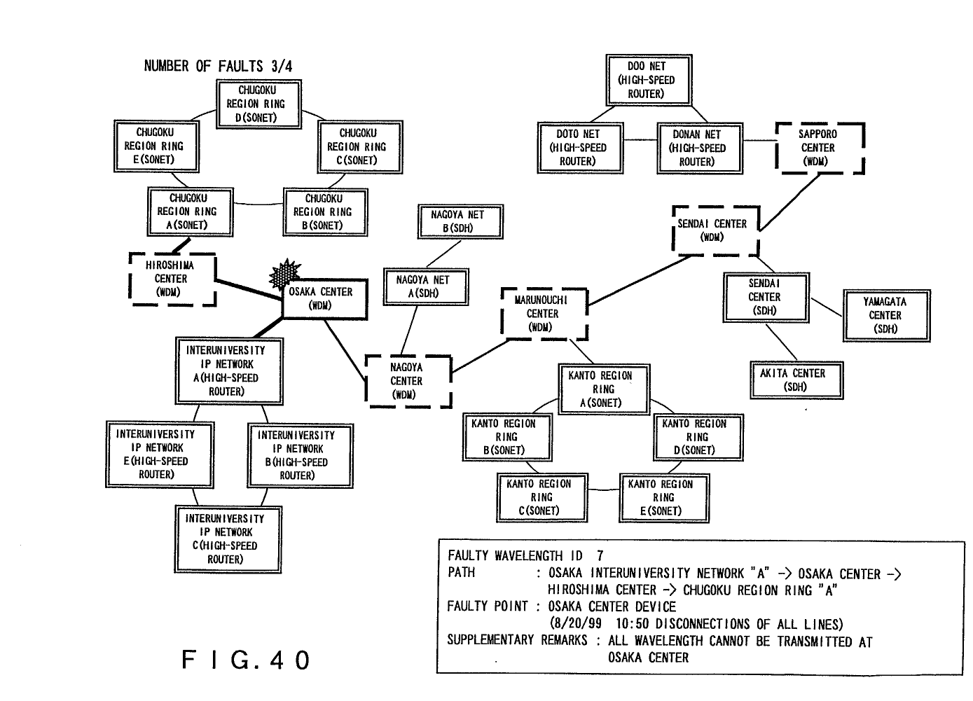

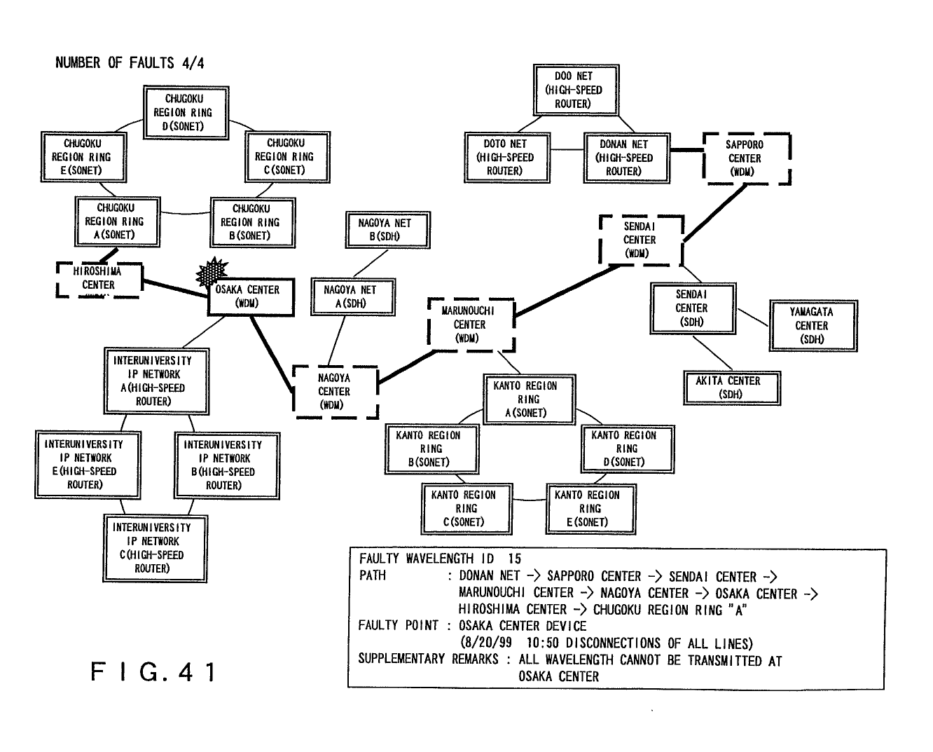

FIGS. 38 through 41 explain one example of a display on the screen of a supervisory control device when a plurality of faults occur at the same time. The example shown in FIGS. 38 through 41 assumes that faults simultaneously occur between the Marunouchi and the Sendai centers, between the Sendai and the Sapporo centers, and at the Osaka center. In FIG. 38, the path on which the fault occurs is indicated by a thick line between the Marunouchi and the Sendai centers. Furthermore, supplementary remarks which notify the wavelength ID on which the fault occurs, the path, the point at which the fault occurs, and the fault state are displayed in the lower right portion of the screen. In FIG. 38, the supplementary remarks describe that the path on which the fault occurs is operated by using a spare wavelength. In FIG. 39, the path on which the fault occurs between the Sendai and the Sapporo centers is indicated by a thick line. Similar to FIG. 38, the supplementary remarks about the wavelength ID on which the fault occurs, the path, and the point at which the fault occurs are displayed in the lower right portion of the screen. Also FIG. 39 describes that the section in which the fault occurs is operated by using a spare wavelength. FIG. 40 shows the state in which a device fault occurs at the Osaka center. According to the information in the lower right portion of the screen, it is impossible to transmit all of wavelengths at the Osaka center, and the path from an Osaka interuniversity network to a Chugoku region ring “A” is indicated as a line disconnection path . In addition, other line disconnection paths exist due to the fact that the Osaka center cannot transmit all of the wavelengths.

If the plurality of faults occur as shown in FIGS. 38 through 41, a screen display is made for each path on which a fault occurs, and all of the paths on which the faults occur are displayed by switching screens, for example, at every 2 seconds. In this way, an administrator can immediately obtain the information about not only at which point a fault occurs in a network, but also which path are unavailable, etc., leading to a significant increase in an efficiency of network maintenance operations.

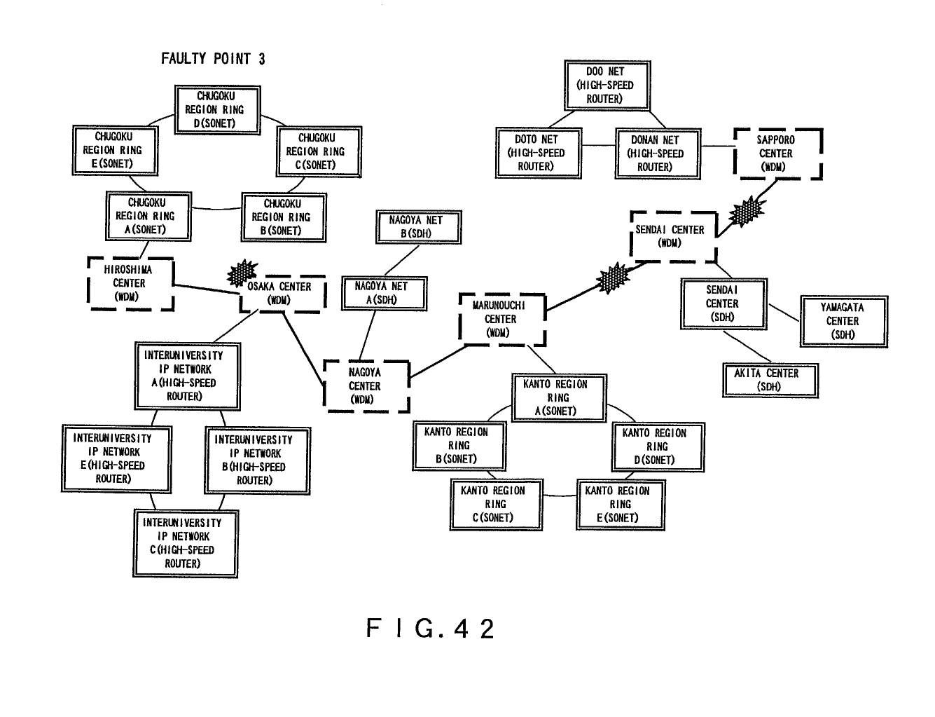

FIGS. 42 through 45 show another example of a display on the screen of the supervisory control device when a plurality of faults occur.

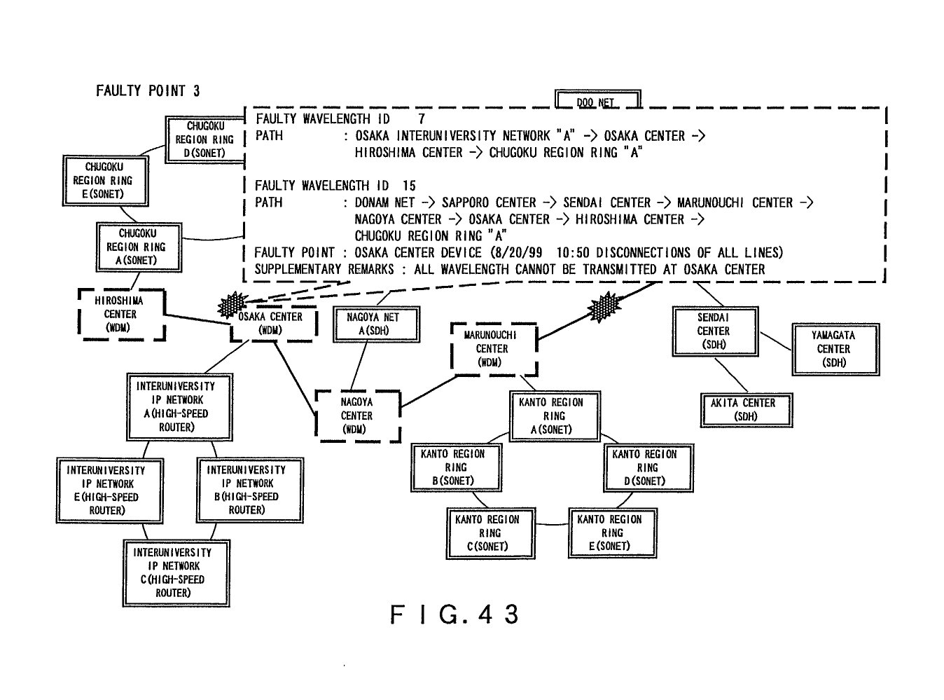

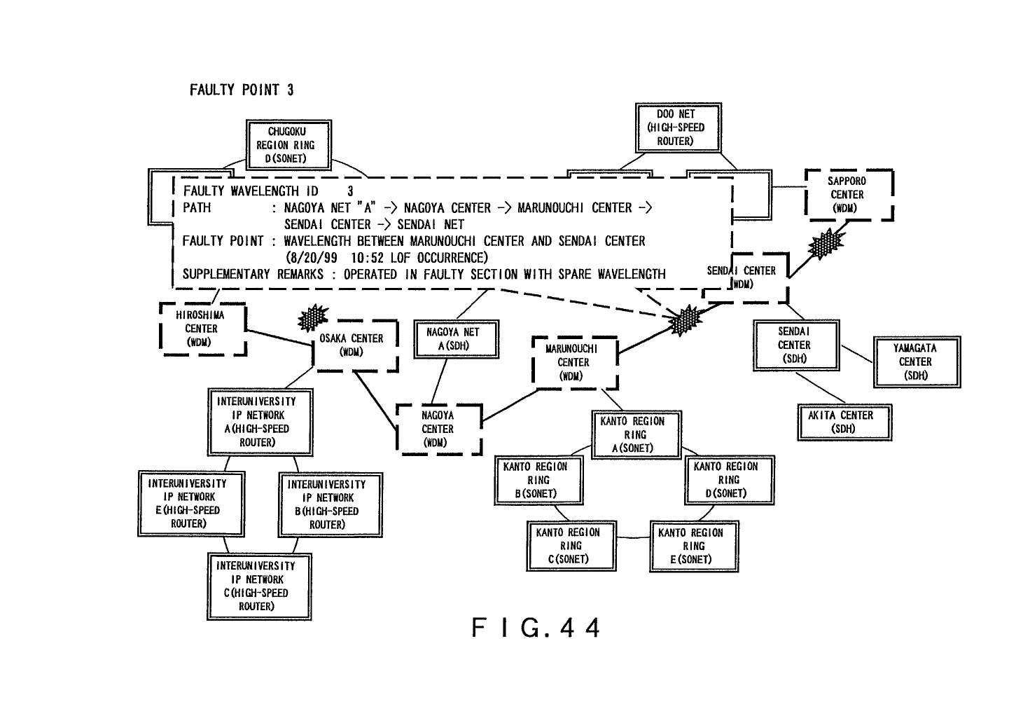

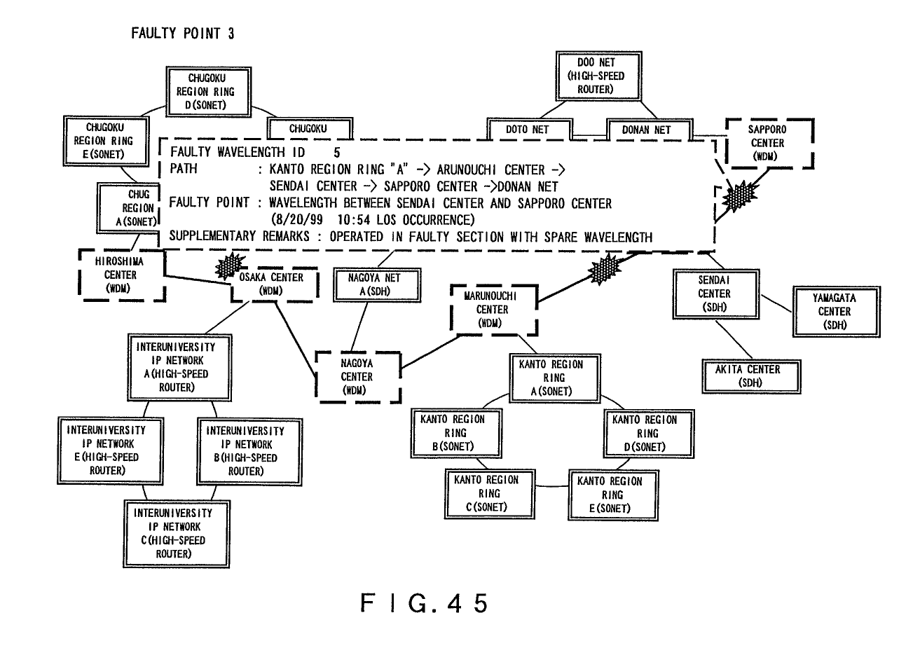

In the example shown in FIGS. 38 through 41, a display is switched for each of the paths on which the faults occur when the plurality of faults arise. However, in this example, the points at which the faults occur are first displayed at one time as shown in FIG. 42. As a result, an administrator can immediately grasp how many faults occur at which points. If the administrator desires to know the contents of the faults, the information shown in FIGS. 43 through 45 can be displayed, for example, by clicking a point at which a fault occurs with a mouse. By way of example, in FIG. 43, the fault occurring at the Osaka center is a device fault, and it is impossible to transmit all of the wavelengths. Therefore, the paths on which the faults occur are proved to be two paths identified by wavelength IDs “7” and “15”. Furthermore, the contents of the faults shown in FIGS. 44 and 45 are “LOS”, and it is proved that the numbers of paths on which the fault occurs are respectively “1” based on the wavelength IDs on which the faults occur.

Also in the displays shown in FIGS. 42 through 45, an administrator can easily grasp a network fault similar to the displays shown FIGS. 38 through 41. In this preferred embodiment, however, not only the points at which faults occur, but also the paths on which the faults occur can be grasped, thereby efficiently performing network maintenance.

According to the present invention, end-to-end path information can be managed by a supervisory control device in a centralized manner by manually or automatically assigning an ID to a wavelength on a network that is configured by optical transmission devices, their transmission paths, and the supervisory control device. Furthermore, a path on which and a point at which a fault occurs can be identified from the managed information. Consequently, the identification of the point at which and the path on which a fault occurs can be simplified when a path configuration is changed or a fault occurs in an optical transmission device network, thereby taking quick measures.

What is claimed is:

1. An optical path managing device in a wavelength multiplexing communications network which interconnects networks using a plurality of different protocols with optical signals having different wavelengths, comprising:
a transmitting unit configuring the networks and the wavelength multiplexing communications network;
a unit assigning an identifier to an optical signal carrying signals exchanged between the networks; and
a supervisory controlling unit having a fault identifying unit which identifies a path on which a fault occurs based on the identifier when the fault arises in the wavelength multiplexing communications network.

2. The optical path managing device according to claim 1, wherein said supervisory controlling unit automatically notifies said transmitting unit of an unused identifier among identifiers based on a request from said transmitting unit.

3. The optical path managing device according to claim 1, wherein
the identifier includes an identifier for identifying said transmitting unit through which the optical signal passes during a transmission.

4. The optical path managing device according to claim 1, wherein
the identifier is assigned to a section overhead of a SONET/SDH frame.

5. The optical path managing device according to claim 1, wherein
the identifier is assigned to information bytes added to a SONET/SDH frame.

6. The optical path managing device according to claim 1, wherein
the identifier is manually assigned to the optical signal by a human being operating said supervisory controlling unit.

7. The optical path managing device according to claim 1, wherein
said supervisory controlling unit further has a displaying unit which displays a configuration of an entire network configured by the networks and the wavelength multiplexing communications network, and also displays contents of a fault in synchronization with the display of the network.

8. The optical path managing device according to claim 7, wherein
said displaying unit highlights a point at which a fault occurs, and a path influenced by an occurrence of the fault.

9. The optical path managing device according to claim 1, wherein
the identifier is notified to said transmitting unit.

10. An optical path managing device which monitors and controls a wavelength multiplexing communications network which interconnects networks having a plurality of protocols, comprising:
a unit assigning an identifier to an optical signal carrying signals exchanged between the networks; and
a fault identifying unit identifying a path on which a fault occurs based on the identifier when the fault arises in the wavelength multiplexing communications network.

11. An optical path managing method for use in a wavelength multiplexing communications network configured by a plurality of WDM transmission devices interconnecting networks which are configured by a plurality of transmission devices and use a plurality of different protocols, comprising:
assigning an identifier to an optical signal carrying signals exchanged between the networks; and
identifying a path on which a fault occurs based on the identifier when the fault arises in the wavelength multiplexing communications network.

12. The method according to claim 11, further comprising:
automatically notifying the transmission devices of an unused identifier among identifiers based on a request from the WDM transmission devices or the transmission devices.

13. The method according to claim 11, wherein the identifier includes an identifier for identifying the WDM transmission devices or the transmission devices through which the optical signal passes during a transmission.

14. The method according to claim 11, wherein the identifier is assigned to a section overhead of a SONET/SDH frame.

15. The method according to claim 11, wherein the identifier is assigned to information bytes added to a SONET/SDH frame.

16. The method according to claim 11, wherein the identifier is manually assigned to the optical signal by a human being.

17. The method according to claim 11, further comprising
displaying a configuration of an entire network that is configured by the networks and the wavelength multiplexing communications network, and displaying contents of a fault in synchronization with a display of the network according to the contents of an occurred fault.

18. The method according to claim 17, wherein
a point at which fault occurs and a path influenced by an occurrence of the fault are highlighted.

19. The method according to claim 11, wherein the identifier is notified to each of the WDM transmission devices and the transmission devices.
